(19) United States
(12) Patent Application Publication
(10) Pub. No.: US 2025/0162902 A1
(43) Pub. Date: May 22, 2025

(54) SYSTEM AND A METHOD FOR MITIGATING CONTAMINATION IN A SWIMMING POOL OR SPA

(71) Applicant: Pentair, Inc., Minneapolis, MN (US)

(72) Inventors: Travis Baldwin, Raleigh, NC (US); Eric Pinnell, Holly Springs, NC (US)

(21) Appl. No.: 18/953,958

(22) Filed: Nov. 20, 2024

Related U.S. Application Data
(60) Provisional application No. 63/601,005, filed on Nov. 20, 2023.

(51) Int. Cl. C02F 1/00; C02F 1/32; C02F 1/467; C02F 103/42

(52) U.S. Cl. CPC C02F 1/008; C02F 1/32; C02F 1/4674; C02F 2103/42; C02F 2209/06; C02F 2209/36; C02F 2209/40; C02F 2303/04

(57) ABSTRACT

A system and a method are provided for mitigating contamination in a swimming pool or spa. An example method receiving a first input at a user interface to activate a contamination mode for the swimming pool or spa. The method may further include outputting an indication of one or more contamination mitigation options at the user interface in association with receiving the first input to activate the contamination mode. The method may further include receiving a second input at the user interface to select a contamination mitigation option from the one or more contamination mitigation options. The method may further include performing one or more contamination mitigation actions associated with the selected contamination mitigation option.

### CROSS-REFERENCE TO RELATED APPLICATIONS

This application claims priority to U.S. Provisional Patent App. No. 63/601,005, filed on Nov. 20, 2023, entitled “SYSTEM AND A METHOD FOR MITIGATING CONTAMINATION IN A SWIMMING POOL OR SPA,” the entire disclosure of which is incorporated herein by reference.

### TECHNICAL FIELD

The present disclosure relates to swimming pools and spas. More particularly, the present disclosure relates to a system and a method for mitigating contamination in a swimming pool or spa.

### BACKGROUND

Swimming pools and spa are increasingly common in residences, offices, hotels, and other places, and can be used by many people. Contaminants containing bacteria or pathogens may be introduced into bodies of water by environmental sources. Other contaminants or debris may be introduced by swimmers and bathers, including sweat, urine, bodily oils or secretions, suntan lotion, and other substances. In other instances, contaminants or debris is introduced into the water by animals. In addition to contributing to high turbidity, the contaminants can also react with disinfectant chemicals to produce chloramines and other disinfection by-products, which can contribute to adverse health effects. Thus, in pool and spa systems, to clean the water, the water is typically passed through a filtration system.

When potentially harmful contaminants are introduced into the water, steps can be taken to minimize the risk of harm to the users of the swimming pool or spa. Currently, taking the appropriate action requires users to manually search for, identify, and perform the necessary steps to ensure the water is free from contamination.

### SUMMARY

A method for mitigating contamination in a swimming pool or spa is provided. The method may include receiving a first input at a user interface to activate a contamination mode for the swimming pool or spa and outputting an indication of one or more contamination mitigation options at the user interface in association with receiving the first input to activate the contamination mode. The method may further include receiving a second input at the user interface to select a contamination mitigation option from the one or more contamination mitigation options and performing one or more contamination mitigation actions associated with the selected contamination mitigation option.

In some examples, the method may include a first input at the user interface to activate the contamination mode associated with a human contamination mode. In this instance, the method may further include activating the human contamination mode based at least in part on receiving the first input. One or more contamination mitigation options may include one or more human contamination mitigation options associated with the human contamination mode.

In other instances, the method may include a first input at the user interface to activate the contamination mode associated with an animal contamination mode. In this instance, the method may further include activating the animal contamination mode based at least in part on receiving the first input. The one or more contamination mitigation options may include one or more animal contamination mitigation options associated with the animal contamination mode.

In some instances, performing the one or more contamination mitigation actions associated with the selected contamination mitigation option of the method may also include outputting an alert that water of the swimming pool or spa may be contaminated or that one or more pool chemical levels may be out of normal range.

In other examples, performing the one or more contamination mitigation actions associated with the selected contamination mitigation option of the method may further include determining whether water in the swimming pool or spa has been sanitized. In some examples, the method may include setting a flow rate of an ultraviolet (UV) sanitizer system to a first flow rate when the water in the swimming pool or spa has been sanitized, and setting the flow rate of the UV sanitizer system to a second flow rate when the water in the swimming pool or spa has not been sanitized, wherein the second flow rate is slower than the first flow rate.

In some examples, the method may further include receiving an input at the user interface to activate a chlorination contamination mitigation option. The method may further include outputting instructions for at least one chlorination dosage correlated with a time frame, wherein each of the at least one chlorination dosage and the correlated time frame are associated with a respective time duration indicating when the water of the swimming pool or spa may be clean (e.g., decontaminated, cleaned, or neutralized), or that one or more pool chemical levels may be within normal range.

In some examples, performing the one or more contamination mitigation actions associated with the selected contamination mitigation option may further include determining that an oxidation-reduction potential associated with the swimming pool or spa is outside a standard or normal range, and dosing the swimming pool or spa water until the oxidation-reduction potential is within the standard range. In other instances, the standard range for the oxidation-reduction potential is greater than 650 millivolts (mV).

In some instances, the method may further include determining a pH level of water in the swimming pool or spa. In this instance, the one or more contamination mitigation options are based on the determined pH level, and selecting a dosage of an additional sanitizer to add to the water in the swimming pool or spa is based at least in part on the determined pH level.

In other examples, the method may further include determining a current level of a chemical in the swimming pool or spa. In this instance, the one or more contamination mitigation options are based at least in part on the chemical level and selecting a dosage of an additional sanitizer to add to water of the swimming pool or spa based on the determined level of the chemical in the water of the swimming pool or spa.

In some instances, the method may further include receiving a third input associated with completion of the one or more contamination mitigation actions and deactivating the contamination mode based at least in part on receiving the third input.

A device for mitigating contamination in a swimming pool or spa is also provided. The device includes a user interface designed to receive a first input to activate a contamination mitigation mode for the swimming pool or spa. The device is also designed to output an indication of at least one contamination mitigation option associated with the contamination mitigation mode and receive a second input to select a contamination mitigation option from the at least one contamination mitigation options. Additionally, the device includes a controller designed to perform one or more contamination mitigation actions based on the selected contamination mitigation option.

In some instances, the user interface may be further designed to output a first notification that the contamination mitigation mode has been activated.

In other instances, the controller may be further designed to output a second notification to cease use of the swimming pool or spa to a mobile device of a user. In this instance, the second notification is associated with activation of the contamination mitigation mode.

In some examples, the controller may be further designed to output a notification that water of the swimming pool or spa may be contaminated or that one or more pool chemical levels may be out of normal range. In this instance, the notification is associated with receiving the second input to select the contamination mitigation option from the one or more contamination mitigation options.

In other examples, the controller may be further designed to output a query to a server to identify a current warning for water borne avian illnesses.

In some instances, the controller may be further designed to output an alert to a server associated with a local animal control to test an animal found in the swimming pool or spa for at least one disease.

In other instances, the user interface may be further designed to output a notification to backwash a filter and replace a media.

A swimming pool or spa control device is provided. The device may include a contamination controller associated with a pool pump, a pool filter, a chemical dispenser, and at least one other pool device. The controller may be designed to receive a first input at a user interface to activate a contamination mode associated with a contamination of the swimming pool or spa and output an indication of one or more contamination mitigation options at the user interface. The controller may be further designed to receive a second input at the user interface to select at least one of the one or more contamination mitigation options and perform one or more contamination mitigation actions associated with the at least one selected contamination mitigation option via at least one of the pool pump, pool filter, chemical dispenser, or the at least one other pool device. The controller may be further designed to deactivate the contamination mode based at least in part on the performance of the one or more contamination mitigation actions.

A swimming pool or spa control device is provided. The device may include one or more memories storing a processor-executable code, and one or more processors coupled with the one or more memories and individually or collectively operable to execute the processor-executable code. The processor-executable code may cause the swimming pool or spa control device to receive a first input at a user interface to activate a contamination mode associated with a contamination of the swimming pool or spa and output an indication of one or more contamination mitigation options at the user interface. The processor-executable code may further cause the swimming pool or spa control device to receive a second input at the user interface to select at least one of the one or more contamination mitigation options, perform one or more contamination mitigation actions associated with the at least one selected contamination mitigation options, and deactivate the contamination mode based at least in part on the performance of the one or more contamination mitigation actions.

Means for mitigating contamination of a swimming pool or spa are provided. The means for may include means for receiving a first input at a user interface to activate a contamination mode for the swimming pool or spa and means for outputting an indication of one or more contamination mitigation options at the user interface in association with receiving the first input to activate the contamination mode. The means for may further include means for receiving a second input at the user interface to select a contamination mitigation option from the one or more contamination mitigation options and means for performing one or more contamination mitigation actions associated with the selected contamination mitigation option.

### BRIEF DESCRIPTION OF THE DRAWINGS

FIG. 1 is a schematic diagram of an example system designed to mitigate contamination in a swimming pool or spa according to disclosed examples;

FIG. 2 is a flow diagram of an example method for mitigate contamination in a swimming pool or spa according to disclosed examples;

FIG. 3 is a block diagram of a controller associated with the system for mitigating contamination in a swimming pool or spa according to disclosed examples;

FIG. 4A illustrates a user interface of the controller of FIG. 3 according to disclosed examples;

FIG. 4B illustrates a first example contamination option at the user interface of FIG. 4A for mitigating contamination in a swimming pool or spa according to disclosed examples;

FIG. 4C illustrates a second example contamination option at the user interface of FIG. 4A for mitigating contamination in a swimming pool or spa according to disclosed examples;

FIG. 4D illustrates a third example contamination option at the user interface of FIG. 4A for mitigating contamination in a swimming pool or spa according to disclosed examples;

FIG. 5A illustrates a first example action at the user interface of FIG. 4A for mitigating contamination in a swimming pool or spa according to disclosed examples;

FIG. 5B illustrates a second example action at the user interface of FIG. 4A for mitigating contamination in a swimming pool or spa according to disclosed examples;

FIG. 5C illustrates a third example action at the user interface of FIG. 4A for mitigating contamination in a swimming pool or spa according to disclosed examples;

FIG. 5D illustrates a fourth example action at the user interface of FIG. 4A for mitigating contamination in a swimming pool or spa according to disclosed examples;

FIG. 5E illustrates a fifth example action at the user interface of FIG. 4A for mitigating contamination in a swimming pool or spa according to disclosed examples; and

FIG. 6 illustrates a flow diagram of depicting an example method for mitigating contamination in a swimming pool or spa according to disclosed examples.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the FIG.s, in which like elements in different FIGS. have like reference numerals. The FIGS., which are not necessarily to scale, depict selected embodiments and are not intended to limit the scope of embodiments of the disclosure. Skilled artisans will recognize the examples provided herein have many useful alternatives and fall within the scope of embodiments of the disclosure.

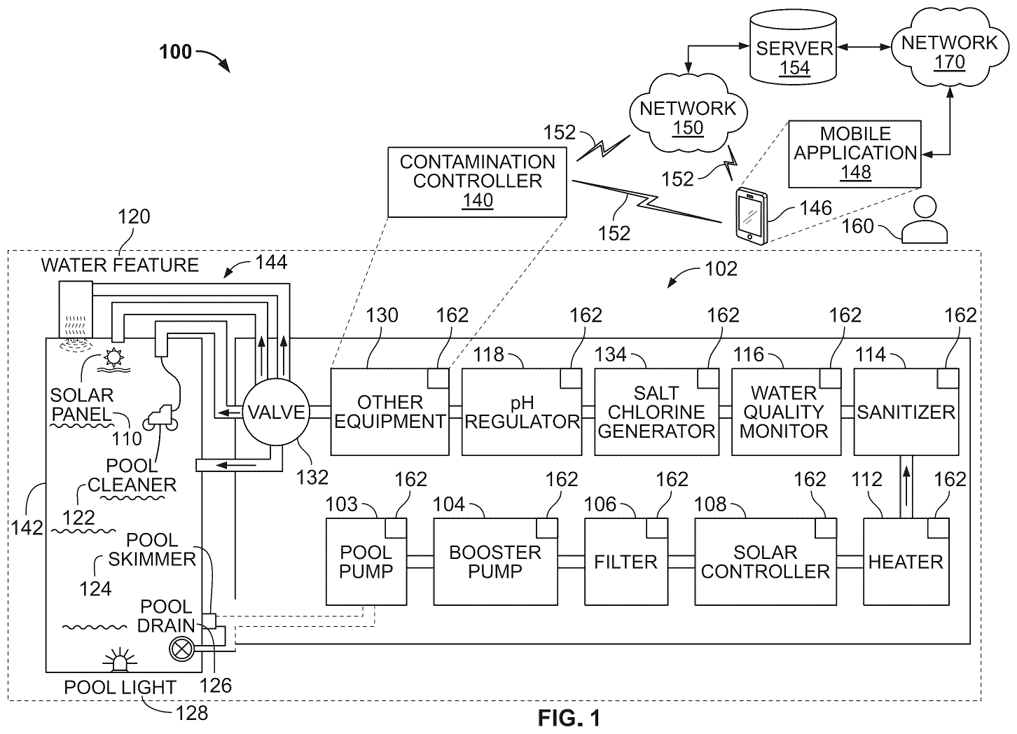

FIG. 1 is a schematic diagram of an example system 100 for mitigating contamination in a swimming pool or spa, according to disclosed examples. A swimming pool 142 with water is shown. A “swimming pool” or “pool” refers to a body in which the water is accumulated and is used for the purpose of swimming, bathing, or the like. For example, the system 100 may include a swimming pool 142 with one or more pool devices 102 designed for use and in communication with the swimming pool 142. In other examples, the system 100 may include a spa and include pool device 102 designed for use with a spa. In other instances, the system 100 may include a pool and a spa and include components that may be used with a pool and spa system. In yet other instances, the system 100 may include a pool or spa device designed for use with a pool or a spa in a residential setting or a commercial setting. More particularly, the system 100 may be provided as a commercial or resident swimming pool, a hot tub, a spa, a plunge pool, and other recreational water venues not specifically discussed herein. When used throughout the disclosure, it will be understood that a “swimming pool” may refer to any of these alternatives.

The pool devices 102 of the system 100 may be provided in communication with each other and the swimming pool 142 to form a fluid circuit 144. The fluid circuit 144 may facilitate water movement from the swimming pool 142 through the pool devices 102 to accomplish various tasks including, for example, pumping, cleaning, heating, sanitizing, lighting, filtering, and the like. Additional arrangements of the system 100 besides those shown in FIG. 1 are also contemplated.

As seen in FIG. 1, the components may include one or more of the following pool devices 102 utilized for operating and maintaining a residential or commercial aquatic system like a pool or spa including, for example, a pool pump 103, a booster pump 104, one or more filters 106, a solar controller 108, one or more solar panels 110, one or more heaters 112, one or more sanitizers 114, a water quality monitor 116, a pH regulator 118, a water feature 120, a pool cleaner 122, a pool skimmer 124, a pool drain 126, a pool light 128, a salt chlorine generator 134, and other devices 130. The other devices 130 may also include a contamination controller 140. At least some of the pool devices 102 may be in communication with one or more power sources and may be in communication with another of the pool devices 102.

In some examples, more than one of each type of the pool device 102 may be included. In instances with more than one of each type of pool device 102, there may be variations between the duplicates of the types of pool device 102 or they may be the same. In other examples, fewer or more pool device 102 than those shown in the example of FIG. 1 may be used.

The system 100 may include one or more controllers including a central controller, local controller, and/or contamination controller 140. The contamination controller 140 (or its logic and functions thereof) may be incorporated into the central controller (e.g., pool automation) and/or individual local device controllers. It should be noted that various communication methodologies and connections may be implemented to work in conjunction with, or independent from, one or more local controllers associated with one or more individual components associated with the system 100 (e.g., a pump controller, a heater controller, etc.).

The contamination controller 140 is designed to assist in mitigating contamination of the system 100. The contamination controller 140 controls the pool device 102 by providing one or more signals that include instructions to the pool device 102 that cause the pool device 102 to perform one or more actions. For example, the contamination controller 140 may send a signal to the heater 112 to increase or decrease the heating to change the temperature of the water. In another example, the contamination controller 140 may instruct a sanitizer 114 to alter a chemical output of the sanitizer 114 to change the sanitization of the water. And yet further examples, the contamination controller 140 may signal the pool pump 103 or the booster pump 104 to change their pump rates (e.g., flow or speed). These are just some examples of how the contamination controller 140 may control the pool device 102, and many others are contemplated. For example, the contamination controller 140 may be able to adjust any electronically controllable component of any of the pool devices 102 to modify an operational status, parameter, or other aspect of the pool device.

The contamination controller 140 may be designed to interface with a mobile device 146, which may be associated with a user 160 of the system 100. The mobile device 146 may be provided in the form of a user device, a wireless device, a remote device, a handheld device, or a subscriber device, or some other suitable terminology, where the “device” may also be referred to as a unit, a station, a terminal, or a client, among other examples. A mobile device 146 may be provided in the form of a personal electronic device such as a cellular phone, a personal digital assistant (PDA), a tablet computer, a laptop computer, or a personal computer. In some examples, a mobile device 146 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The contamination controller 140 may be in communication with the mobile device 146 over one or more communication links 152. In some examples, the contamination controller 140 may communicate with the mobile device 146 directly via a device-to-device (D2D) communication link (for example, in accordance with a peer-to-peer (P2P), D2D, or sidelink protocol).

In some examples, the contamination controller 140 may communicate with the mobile device 146 through a network 150. The communication links 152 may include downlink transmissions (for example, forward link transmissions) from the network 150 to the contamination controller 140 or the mobile device 146, uplink transmissions (for example, return link transmissions) from the mobile device 146 or the contamination controller 140 to the network 150, or both, among other configurations of transmissions.

The network 150 may be provided in the form of, for example, the Internet, intranets, extranets, wide area networks (WANs), local area networks (LANs), wired networks, wireless networks, cloud networks, or other suitable networks, or any combination of two or more such networks. For example, such networks may include cellular networks, satellite networks, cable networks, Wi-Fi networks, Ethernet networks, RS485 connections, and other types of networks. In some instances, network 150 may be operating in accordance with a Long Term Evolution (LTE) network, an LTE-Advanced (LTE-A) network, an LTE-A Pro network, a New Radio (NR) network, or other systems and radio technologies, including future systems and radio technologies not explicitly mentioned herein. In some instances, the network 150 may be provided in the form of a short-range network (such as Bluetooth, Near-field communication (NFC), etc.). In one example, the network 150 may be an isolated private network utilizing a private Internet Protocol (IP) address and limiting access to the network 150. In some examples, the network 150 may include one or more computing devices that may be arranged, for example, in one or more server banks or computer banks, or other arrangements.

In some instances, the mobile device 146 may be connected with the server 154 through the network 150. Alternatively, the mobile device 146 may be in communication with a second network 170. The second network 170 may be any type of network as described herein. However, in some examples, the network 150 may be more than one network, and may be a different network than those connected to the pool device 102.

The mobile device 146 may store and execute one or more mobile applications 148. The one or more mobile applications 148 may include a swimming pool mobile application. The one or more mobile applications 148 may be able to interface with, or otherwise interact with, the contamination controller 140.

The pool device 102 may further include one or more valves 132 to control the individual pool device 102. The valves 132 may be controlled manually or remotely via the contamination controller 140, the user 160 device 146, individual pool device 102, or any combination thereof.

Each of the pool devices may be associated with identification information, which may include information about the type of pool device 102 (for example, a device type) and other features, settings, options, parameters, characteristics, or distinguishing aspects of the device. The identification element may be assigned by a manufacturer, by the user 160, dealer, servicer, or by a system engine of the pool device 102. The identification information may further include a product serial number, be assigned when a user 160 registers the component, or otherwise be associated with a specific user 160 account after installation. The contamination controller 140 may use the identification information to provide one or more signals regarding the contamination to the correct pool device 102 or to identify from which pool device 102 it received one or more signals.

Each of the pool devices 102 may further include, or be in communication with, one or more sensors 162 162. The sensors 162 may be provided in the form of an integrated sensor, an external sensor, a sensing unit connected to or in communication with the pool device 102, or a combination thereof. The sensors may be defined by several different sensors 162, sensor configurations, or other monitoring or measuring devices. This may include a sensor unit with an individual sensor, a sensor unit with multiple sensors 162, a single sensor 162 with multiple sensing capabilities, or a combination thereof.

In various examples, the sensor 162 integrated with or removably attached to the pool device 102 is designed to monitor operating parameters of the pool device 102. Multiple sensors 162 may be installed based on the size, specifications, and complexity of the system 100 to collect information. The sensor 162 may be one or more of a power sensor, a temperature sensor, a pressure sensor, a gyroscope, an accelerometer, a vibration sensor, a flow sensor, a current sensor, a voltage sensor, a power sensor, a frequency sensor, an energy sensor, a fault sensor, an audio sensor, an optic sensor, a piezoelectric sensor, a capacitance sensor, or a combination thereof. In some examples, the sensor 162 may include more than one of a particular type of sensor. Moreover, the sensor 162 may be connected to, and designed to collect data from, one or more of the pool devices 102. In this instance, the sensor 162 may further include different types of sensing components to collect and extract information related to the operating parameters, which may relate to contamination, and send the data set to the contamination controller 140 or another system component via a wireless or wired connection. In other examples, the sensor 162 may be located at a different geographic location than the respective pool device 102. The one or more sensors 162 may send data to the contamination controller 140 regarding status of the respective pool device 102.

Each of the pool devices 102 may collect, send, and receive data sets to and from the other pool devices 102 and/or to the contamination controller 140. The data collected and sent from the pool devices may include, at least, specific component information from the manufacturer for the pool devices 102 and operating parameters. As described above, this may include information entered either directly or indirectly from the user 160, but may also include information from the manufacturer, such as routine maintenance schedules, system updates, sensor data, or subscription settings. The data collected and sent via the pool device 102 may further include operating parameters collected from the sensors 162 associated with and connected to one or more of the pool devices 102. Some or all of this data may be provided to the contamination controller 140.

Some of the pool devices 102 shown in FIG. 1 may include an integrated sensor 162 or an external sensor 162 for collecting and extracting data associated with the identification element, operating parameters, and contamination for the pool device 102. Non-limiting examples of the pool devices 102 and the extracted data are described herein, but additional pool devices 102 and operating parameters are contemplated herein.

As an example, the pool pump 103 and booster pump 104 may include one or more sensors 162 designed to detect power, vibration, current, flow, pressure, temperature, frequency, or a combination thereof. The power sensor 162 may measure when the pool pump 103 and booster pump 104 are connected to power, and whether the pump(s) are activated. Additionally, some pool pumps 103 and booster pumps 104 have a soft start mode or similar controlled or reduced power mode, which may be measured and detected by the power sensor. The vibration sensor 162 may measure vibration levels to identify electromagnetic or mechanical imbalance, loose components, rubbing parts, part failure, cavitation, or resonance. Some examples may further include an accelerometer to detect if a pool device 102 becomes unlevel or sustains an impact force. A current sensor 162 may measure the current flowing through the pump(s) using a non-intrusive method. A flow sensor 162 may measure the flow of water that is pumped by a motor of the pool pump 103 and the booster pump 104 and determine a health of the motor by determining if the flow rate is unexpectedly high or low based on the particular application and various threshold metrics. The flow sensor 162 may also include a flow switch or a fluid velocity sensor 162 to detect abnormal flow rates. In some instances, the contamination controller 140 may suspect or detect a contamination based on abnormal flow rates signaled from the flow sensor 162.

A pressure sensor 162 may monitor the pressure in air compressors, heat exchangers, and similar that all use pumps to push air or water through their respective systems. The pressure sensor 162 may further measure an input and differential pressure at the head of the pool pump 103 or the booster pump 104. The pressure sensor 162 may be designed to overcome the faults and monitor the pool pump 103 and booster pump 104. Further, the temperature sensor 162 may monitor the temperature and help to detect any abnormal temperature rise or fall due to any malfunction or failure, this may include but is not limited to temperature measurements at the inlet, outlet, and motor. The frequency sensor 162 may measure the frequency of the pool pump 103 and the booster pump 104 and may be used for controlling Variable Frequency Drives (VFDs) that may be associated with or connected to either the pool pump 103 or the booster pump 104. In some examples, an encoder may be used to measure and monitor the velocity of a rotor/impeller of the pool pump 103 and the booster pump 104. Other sensors 162, such as the voltage sensor, may monitor the input voltage and calculate the power factor of a motor of the pool pump 103 and the booster pump 104 using both current and voltage values of the system 100 or the values detected by the sensors 162 connected to each of the pool pump 103 and the booster pump 104. The contamination controller 140 may suspect or detect a contamination based on information signaled from the pressure sensor 162 (e.g., a sudden or gradual pressure drop or change).

In another instance, the filter 106 may include a sensor 162 designed to detect: pressure, flow, fluid velocity, or a combination thereof. The pressure sensor 162 may detect and monitor differential pressure to identify when the filter 106 may be dirty or clogged with debris. Routine maintenance alerts may be provided to regularly clean the filter 106 and extend the life of the filter 106. The flow sensor 162 may include a flow switch or a fluid velocity sensor 162 to measure the flow status and flow rate at the inlet, outlet, and backwash ports of the filter 106. Additionally, the flow sensor 162 may measure the flow rate to help detect potential leaks in the filter 106 and a filter compartment that houses the filter 106. The contamination controller 140 may suspect or detect a contamination based on information signaled from the filter 106 or its respective sensors 162.

In some instances, the solar controller 108 may include a sensor 162 designed to detect: power, voltage, current, temperature, or a combination thereof. The power sensor 162 may determine when the solar controller 108 is connected to power, and whether it is activated. The voltage sensor 162 may monitor the input voltage and detect any upstream electrical system faults. The voltage sensor 162 may also measure the control voltage and verify the output signal to a solar valve actuator is within an acceptable range and may verify the solar controller 108 relay voltage is within an acceptable range. In other examples, other ranges may be used. A temperature sensor 162 may be used to monitor an internal temperature of the solar controller 108 and identify if any internal components, including electronic components, are overheating. The contamination controller 140 may suspect or detect a contamination based on information signaled from the solar controller 108 or its respective sensors 162.

In another example, the solar panels 110 may include a sensor 162 designed to detect: power, voltage, current, solar radiation, or a combination thereof. The power sensor 162 may measure when the solar panels 110 are activated. The voltage and current sensors 162 may be used to detect power generation and the power output of the solar panels 110. In addition to the data analytics techniques described herein, the data collected by the sensor(s) may be used to produce energy reports and historical usage data displayed on the mobile device 146. The data may also be used by the other pool device devices to evaluate performance and propose updates. A photosensor 162 may be used to detect levels of solar radiation (for example, the photosensor 162 may determine if it is a sunny day or a cloudy day). The contamination controller 140 may suspect or detect a contamination based on information signaled from the solar panels 110 or its respective sensors 162.

In yet another instance, the heater 112 may include a sensor 162 designed to detect: power, voltage, current, temperature, pressure, or a combination thereof. The power sensor 162 may measure when the heater 112 is connected to power, and whether it is activated. The voltage sensor 162 may monitor the input voltage and detect any upstream electrical system faults. The voltage sensor 162 may also measure voltage drop to determine the power consumption of the heater 112. The current sensor 162 may detect potential shorts in the heater 112 by identifying abnormal power consumption or current spikes. The temperature sensor 162 may be used to monitor the internal temperature of the heater 112 including the heating elements. The temperature sensor 162 may also measure the temperature at an inlet and an outlet to verify the water temperature is being heated according to the heater 112 controls and settings. The pressure sensor 162 may measure differential pressure between different pool device devices to identify scale accumulation or fouling of a water passage in the heater 112. The contamination controller 140 may suspect or detect a contamination based on information signaled from the heater 112 or its respective sensors 162.

In another instance, the water quality monitor 116 may include a sensor 162 designed to detect: power, voltage, flow, resistance, water chemistry, or a combination thereof. The power sensor 162 may measure when the water quality monitor 116 is connected to power, and whether it is activated. The voltage sensor 162 may monitor the input voltage and detect any upstream electrical system faults. The voltage sensor 162 may also measure a battery level if the water quality monitor 116 is battery-powered or includes a battery pack. The flow sensor 162 may also include a flow switch and may monitor water flow at an input and an output of the water quality monitor 116 and may identify potential clogs in the monitoring system. The flow sensor 162 may further determine if the flow velocity is sufficient for proper operating conditions for the water quality monitor 116. The contamination controller 140 may suspect or detect a contamination based on information signaled from the water quality monitor 116 or its respective sensors 162.

In other examples, the sanitizer 114 may be a chemical dispenser or a UV sanitizer. The sanitizer 114 may include a sensor 162 designed to detect: power, radiant energy, resistance, voltage, current, pressure, or a combination thereof. The power sensor 162 may measure when the sanitizer 114 is connected to power, and whether it is activated. In some examples, the sanitizer 114 is an Ultraviolet (UV) Light sanitizing device and a photosensor 162 may be used to measure the radiant energy of the sanitizer 114 to also determine if the sanitizer 114 is activated. The resistance sensor 162 may determine the electrical resistance across the UV bulb to verify the bulb is properly installed and within a functional range. Irregular resistance measurements may indicate a replacement bulb is needed for the sanitizer 114. The voltage sensor 162 may monitor an input voltage and detect any upstream electrical system faults. The voltage sensor 162 may also measure voltage drop to determine the power consumption of the sanitizer 114. The current sensor 162 may measure the current in the sanitizer 114 system to verify the circuit is working properly. Low or non-existent current measurements may indicate that a replacement bulb is needed for the sanitizer 114. The pressure sensor 162 may measure differential pressure to detect scale or fouling through a water passage in the sanitizer 114. The contamination controller 140 may suspect or detect a contamination based on information signaled from the sanitizer 114 or its respective sensors 162.

In a further instance, the pH regulator 118 may include a sensor 162 designed to detect: power, voltage, current, level, chemistry, flow, or a combination thereof. The power sensor 162 may measure when the pH regulator 118 is connected to power, and whether it is activated. The voltage sensor 162 may monitor the input voltage and detect any upstream electrical system faults. The current sensor 162 may measure the current in the pH regulator 118 system to verify that the circuit is working properly. Abnormal current measurements or an abnormal power consumption reading may indicate a malfunction. A chemical tank level associated with the pH regulator 118 may be measured by a level sensor, such as but not limited to: a float switch, force sensor, or similar. The chemical sensor 162 may be used to identify chemical properties within the chemical tank. In some examples, one or more electrodes, or similar, may be used to measure a difference in the electrical potential between a pH electrode and a reference electrode. The flow sensor 162 may include a flow switch or a fluid velocity sensor 162 to measure the rate at which chemicals are dispensed through the pH regulator 118 system. In some examples, the flow sensor 162 may also be integrated with, or otherwise communicate with, the chemical sensor 162 to measure the type and quantity of chemical(s) dispensed. In some examples, an encoder may be used to measure, monitor, or detect the rotational position and velocity of a dispensing component of the pH regulator 118. The contamination controller 140 may suspect or detect a contamination based on information signaled from the pH regulator 118 or its respective sensors 162.

In another example, the water feature 120 may include a sensor 162 designed to detect: power, flow, pressure, or a combination thereof. The power sensor 162 may measure when the water feature 120 is connected to power, and whether it is activated. The flow sensor 162 may include a flow switch or fluid velocity sensor, or similar, to measure the flow rate through the water feature 120. The pressure sensor 162 may be used to detect a water depth at a bottom surface of the water feature 120. The pressure sensor 162 may also communicate with the flow sensor 162 to measure the flow rate through the water feature 120. The contamination controller 140 may suspect or detect a contamination based on information signaled from the water feature 120 or its respective sensors 162.

In yet another example, the pool cleaner 122 may include a sensor 162 designed to detect: power, voltage, pressure, or a combination thereof. The sensor 162 may also determine if debris should be emptied from the cleaner. The power sensor 162 may measure when the pool cleaner 122 is connected to power, and whether it is activated. The voltage sensor 162 may monitor the input voltage and detect any upstream electrical system faults. The pressure sensor 162 may measure a suction level in a suction line of the pool cleaner 122. An encoder may be used to detect whether one or more spinning motors of the pool cleaner 122 are rotating properly. As with the other pool device devices described herein, the monitored measurements may vary depending on the manufacturer and type of pool cleaner 122. The contamination controller 140 may suspect or detect a contamination based on information signaled from the pool cleaner 122 or its respective sensors 162.

In a further instance, the pool skimmer 124 may include a sensor 162 designed to detect pressure. A differential pressure sensor 162 may detect if there is a clog in a skimmer basket of the pool skimmer 124 or if debris is interfering with air being induced in an equalizer line of the pool skimmer 124. In some examples, an encoder may be used to detect a position of a weir installed in the pool skimmer 124. The contamination controller 140 may suspect or detect a contamination based on information signaled from the pool skimmer 124 or its respective sensors 162.

In yet another example, the pool drain 126 may include a sensor 162 designed to detect: temperature, flow, pressure, or a combination thereof. The temperature sensor 162 may measure the temperature of the water output flowing through the pool drain 126. The flow sensor 162 may include a flow switch or fluid velocity sensor, or similar, to measure the flow rate of water through the pool drain 126. The pressure sensor 162 may measure a pool water level. The pressure sensor 162 may also measure a differential pressure to detect if the pool drain 126 may be clogged. The contamination controller 140 may suspect or detect a contamination based on information signaled from the pool drain 126 or its respective sensors 162.

In another example, the pool light 128 may include a sensor 162 designed to detect one or more of power, voltage, current, resistance, ambient light, or a combination thereof. The power sensor 162 may measure when the pool light 128 is connected to power, and whether it is activated. The voltage sensor 162 may measure the input voltage to the pool light 128 and detect any upstream electrical system faults. The current sensor 162 may measure the current through the pool light 128 and may be used with the voltage sensor 162 to measure power consumption. The voltage sensor 162 or the current sensor 162 may also detect when there is an abnormal power consumption measurement, which may indicate a malfunction with the pool light 128. The ambient light sensor 162 may detect a brightness level of the area surrounding the pool or spa and may send one or more signals to the pool light 128 to turn on when the ambient light drops below an ambient light threshold. In some examples, the pool light 128 may include multiple pool lights and may also include advanced lighting controls such as animation, color, dimming, timer controls, etc. The advanced lighting control features for the pool light 128 may include a sensor 162 to detect and measure system variables or other operating parameters associated with the one or more lighting control features. In some examples, the resistance may also be measured to identify electrical shorts, faults, or when a light bulb or diode needs to be replaced. The contamination controller 140 may suspect or detect a contamination based on information signaled from the pool light 128 or its respective sensors 162.

In another instance, the one or more valves 132 may include a sensor 162 designed to detect: voltage, current, position, flow, or a combination thereof. The voltage sensor 162 may monitor the input voltage and detect any upstream electrical system faults. The voltage sensor 162 may also measure the control voltage and verify the output signal to a valve actuator is within a range. In other examples, other ranges may be used. The current sensor 162 may measure the current in the valve system and detect if there is an abnormal current measurement. Abnormal current measurements or an abnormal power consumption reading may indicate a malfunction in the valve(s). The position of a valve actuator or shaft may be detected using a position sensor, encoder, or similar. The flow switch may measure the flow rate through the valve(s) and detect if a valve port is not receiving an expected flow. The contamination controller 140 may suspect or detect a contamination based on information signaled from the valves 132 or its respective sensors 162.

In a further instance, the other device 130 may include a sensor 162 designed to detect operating parameters associated with components of the other device 130 (for example, power status, operational mode, flow, pressure, chemical composition, calibration status, and other parameters). The contamination controller 140 may suspect or detect a contamination based on information signaled from the other device 130 or its respective sensors 162.

In another example, the sensor 162 (for example, any of the sensing components, sensors 162, or other monitoring devices discussed above) may send data associated with the operating parameters and historical data of the pool device 102 continuously, at scheduled intervals, or in response to a request or other system event. In this example, the request or system event may include user 160 input received at the mobile application 148, which may be provided to the contamination controller 140. For example, if a user 160 wanted to check the temperature of the pool or spa, the mobile application 148 may receive this request and transmit a command to the contamination controller 140, which may provide an instruction to a sensor, in communication with the pool device 102, to collect the current temperature reading and transmit the information back to the mobile device 146 and process the data to generate a display to be displayed on the mobile device 146. In some examples, the information may be displayed at a display device associated with the contamination controller 140.

Further, each of the one or more pool devices 102 may be connected to a server 154 through a network 150. The one or more pool devices 102 may transmit a status associated with the one or more pool devices 102 to the server through a network 150. The status may be a latest status, current status, or a previous status. In some examples, a status associated with the one or more pool devices 102 may correspond to a turn-on status, a turn-off status, a turn-on time status, a turn-off time status, light color status, temperature setpoints of heaters or chillers, a speed or flowrate of pumps, a percentage output of chlorine generators, speed of blowers, feed rate of chemical feeders, position of automatic valves, a contamination status, a contamination mitigation status, and the like. The pool device 102 may send the status iteratively, upon request, periodically based on a time interval, or when a status change has been detected.

The contamination controller 140 may receive information associated with a contamination of the swimming pool or spa based on user input, sensor data, or status changes, for example. The contamination controller 140 may receive a first input at a user interface to activate a contamination mode for the swimming pool or spa. The contamination controller 140 may output an indication of one or more contamination mitigation options at the user interface in association with receiving the first input to activate the contamination mode. The contamination controller 140 may receive a second input at the user interface to select a contamination mitigation option from the one or more contamination mitigation options and perform one or more contamination mitigation actions associated with the selected contamination mitigation option.

In some examples, a device for mitigating contamination in a swimming pool or spa may include a user interface and a controller. The controller may be the contamination controller 140. The user interface may be designed to receive a first input to activate a contamination mitigation mode for the swimming pool or spa, output an indication of at least one contamination mitigation option associated with the contamination mitigation mode, and receive a second input to select a contamination mitigation option from the at least one contamination mitigation option. The controller may also be designed to perform one or more contamination mitigation actions based at least in part on the selected contamination mitigation option. In some examples, the user interface may be integrated with the controller. In other examples, the user interface may be external to the controller.

In some examples, the contamination controller 140 may be a swimming pool or spa control device. The contamination controller 140 may include one or more memories storing a processor-executable code and one or more processors coupled with the one or more memories. The one or more processors may be individually or collectively operable to execute the processor-executable code to cause the swimming pool or spa control device to receive a first input at a user interface to activate a contamination mode associated with a contamination of the swimming pool or spa and output an indication of one or more contamination mitigation options at the user interface and receive a second input at the user interface to select at least one of the one or more contamination mitigation options. The one or more processors may be further individually or collectively operable to execute the processor-executable code to perform one or more contamination mitigation actions associated with the at least one selected contamination mitigation option and deactivate the contamination mode based at least in part on the performance of the one or more contamination mitigation actions.

Further, the contamination controller 140 may also be connected to a mobile device 146 of a user 160 for transmitting oxidation-reduction potential (ORP) and pH values to the mobile device 146 to notify the user 160 whether these ORP and pH values are within acceptable ranges. The user 160 may be an owner, an operator, or a user of the swimming pool or spa 142.

Both the user 160 and the contamination controller 140 may detect contamination in the swimming pool or spa 142. The determination of whether the water of the swimming pool or spa is contaminated may be associated with whether one or more pool chemical levels may be out of normal range. Alternatively, the determination of whether the water of the swimming pool or spa may be clean (e.g., decontaminated, cleaned, or neutralized) may be associated with whether one or more pool chemical levels are within normal range.

The contamination may include, but is not limited to, any contamination that may be caused by a human (for example vomit, blood, stool, diarrhea, etc.), any contamination that may be caused by an animal (for example bird, snake, dig, rodent, raccoon, etc.), pollutants, chemicals, heavy metals, and the like.

In some instances, contamination may be determined by visual inspection. In other instances, contamination may also be defined by or correlated to the water quality of the pool or spa, which may be determined via the measurement of one or more physical parameters or chemical parameters of a sample of the pool or spa water. The physical and chemical parameters may include but are not limited to, a turbidity level, a total dissolved solids level, a pH level, an alkalinity level, a cyanuric acid concentration, an oxidation-reduction potential, a heavy metal concentration, a microbial concentration, an algae concentration, an ozone concentration, a total chlorine level, a free chlorine level, or a combined chlorine level. After determining a value of at least one physical or chemical parameter, the value of the parameter may be compared to a predefined threshold value or range. If the value of the parameter is outside of the predefined threshold range or does not equal the parameter's threshold value, the system 100 (e.g., contamination controller 140) may determine that the water is contaminated and provide a warming, recommendation, and/or mitigation suggestion to help the consumer maintain the pool or spa proper water chemistry balance and return the water to a decontaminated state.

Generally, the sensor(s) 162 disclosed herein are designed to detect, directly or indirectly, at least one physical parameter and/or at least one chemical parameter of a water sample. For example, the sensors detect a concentration of a substance within the water sample. In some instances, the sensors 162 may detect at least one of a turbidity level, a total dissolved solids level, a pH level, an alkalinity level, a cyanuric acid concentration, an oxidation-reduction potential, a heavy metal concentration, a microbial concentration, an algae concentration, an ozone concentration, a total chlorine level, a free chlorine level, or a combined chlorine level of the water sample. To measure the at least one physical and/or chemical parameter of the water sample, the sensors 162 may be provided in the form of a test strip, a drop test, a series of drop tests, a spectrometer, a colorimeter, an ammeter, or combinations thereof.

The at least one physical and/or chemical parameter obtained by the sensors 162 are provided as an input to the contamination controller 140 and the contamination controller 140 may use the input to determine what mitigation actions may be used to adjust the water chemistry of the consumer's pool if the at least one physical and/or chemical parameter of the water sample falls outside of a predefined range. In addition, the contamination controller 140 may estimate an action that may re-balance the pool's water chemistry, determine when the water of the swimming pool or spa may be contaminated, or that one or more pool chemical levels may be out of normal range, and/or provide alert when the water of the swimming pool or spa may be clean (e.g., decontaminated, cleaned, or neutralized), or that one or more pool chemical levels may be within normal range.

In some instances, the contamination controller 140 may automatically detect any of the above-mentioned contamination in the swimming pool or spa 142. In this instance, the contamination controller 140 may rely on information received from one or more sensors 162 such as a camera around the swimming pool or spa 142, any sensor installed inside the swimming pool or spa 142 sensing the water of the swimming pool or spa 142, or one or more sensors installed outside and around the swimming pool or spa 142. Additionally, the contamination controller 140 may determine the water chemistry of the water of the swimming pool or spa 142 to detect contamination in the swimming pool or spa 142.

In other instances, the user 160 may manually detect any of the above-mentioned types of contamination in the swimming pool or spa 142.

The contamination controller 140 may include a user interface that provides one or more contamination options to the user 160 for handling contamination detected in the swimming pool or spa 142. The contamination controller 140 may also suggest or perform the one or more actions to mitigate the contamination in the swimming pool or spa 142. The user 160 may use the user interface of the contamination controller 140 to provide input via making selections of options.

For example, the contamination controller 140 may transmit the ORP and pH values to the server 154 for further processing and analytics. The contamination controller 140 may also transmit a request to the server 154 to provide recurring information regarding the latest guidelines for mitigating contamination in the swimming pool or spa 142. Further, the server 154 may send requested information to the contamination controller 140 on a periodical basis. Such information may include, but is not limited to, software updates and notifications.

The server 154 may be connected to the mobile device 146 through a network 150. In this instance, the mobile device 146 may be enabled to receive information from the server 154 directly.

In some examples, the networks 150 and 170 may correspond to a wireless network such as a cellular network (i.e., Global System for Mobile Communication (GSM), Long-Term Evolution (LTE), Code Division Multiple Access (CDMA), etc.), Short-range network (such as Bluetooth, Near-field communication (NFC)), etc.

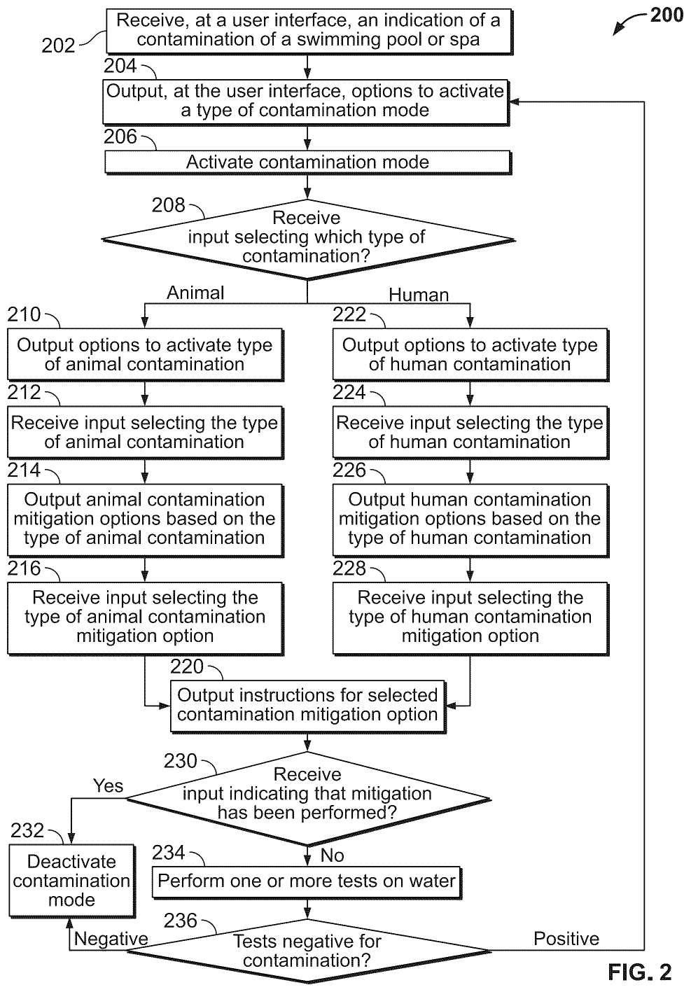

FIG. 2 is a flow diagram of an example method 200 for mitigate contamination in a swimming pool or spa according to disclosed examples. The method 200 may implement or be implemented by aspects of the system 100. For example, the method 200 may be implemented by one or more of the contamination controller or a mobile device, which may be similar to or include aspects of the contamination controller 140 or the mobile device 146 as illustrated by or described with reference to FIG. 1. In some instances, the communications and signals described herein may be sent from or between different devices using one or more networks, such as the network 150 or the network 170 as illustrated by or described with reference to FIG. 1.

At 202, the method 200 may receive, at a user interface, an indication of a contamination of a swimming pool or spa. The determination of whether the water is contaminated may be made using one of the methodologies described herein, including for example, determining if the at least one physical and/or chemical parameter of the water sample falls outside of a predefined range. The use of the input may also be used to determine what mitigation actions may be used to adjust the water chemistry of the pool if the at least one physical and/or chemical parameter of the water sample falls outside of a predefined range.

The user interface may be provided in the form of a graphical user interface associated with the contamination controller 140 or associated with the mobile device 146. In some examples, the graphical user interface may be output at a display device that may be located at the contamination controller 140 or may be external to the contamination controller 140. In other examples, the graphical user interface may be output at a display device that may be a screen of a mobile device 146. In some examples, the indication of the contamination may be verbal, auditory, or via any other input method.

In some examples, the method 200 may include outputting an alert or warning that the water of swimming pool or spa is contaminated using one of the methodologies described herein. The alert may be a visual alert on a display device, an audible alert, or a haptic alert, such as a vibration at a mobile device. In some examples, the indication of the contamination of the swimming pool or spa may be a confirmation of the contamination based on the alert. For example, if one or more pool devices 102 sends a signal to the contamination controller 140 that indicates the pool or spa may be contaminated, the contamination controller 140 may output an alert of contamination at an output device of the contamination controller 140 or the mobile device 146. The contamination controller 140 may also output a query to the user to confirm that the pool or spa may be contaminated. However, in other examples, the user provides the indication that the pool or spa is contaminated using a user interface that enables the user to provide such a notification to the contamination controller 140.

At 204, the contamination controller 140 may output, at the user interface, one or more options to activate a type of contamination mode. The output may be at an output device of the contamination controller 140, such as a display device, or a display device of the mobile device 146. The output may be graphical, audible, or any other means of providing an indication. The contamination controller 140 may provide the user with options to select which type of contamination they think has occurred, such as biohazard contaminations including human contamination or animal contamination, microorganisms, viral, bacterial, sewage, plants, and the like, or chemical contamination such as heavy metals, nitrates, pesticides, agricultural, air pollutants, and the like. A user may observe the pool or spa to determine which type of contamination may be present and provide a selection of the type of contamination to the contamination controller 140. In some examples, where the contamination is not known by the user, the contamination controller 140 may provide an option for the user to rank likelihoods of different types of contamination.

In some examples, the contamination controller 140 may determine the type of contamination present without input from the user. In some cases, the contamination controller 140 may use machine learning or artificial intelligence to estimate the type of contamination may be present, based on various sensor data from the pool device, geography, season, weather, recent use of the pool or spa, recent events, some input from the user, and other information. In some instances, the contamination controller 140 may provide a series of questions to the user to narrow down the contamination possibilities.

The method 200 may activate a contamination mode at 206. The contamination mode may be based on the type of contamination, such as an animal or human contamination, or any other type of contamination described herein. At 208, upon receiving the input selecting which type of contamination is likely present, the method 200 may determine which type of contamination is present. The activated contamination mode may be a contamination mode based on the type of contamination, such as a human contamination mode or an animal contamination mode. Once the contamination mode is activated, the contamination controller 140 may perform one or more precautionary actions, such as shutting off a water supply and notifying current or future users that the swimming pool or spa may be contaminated via an alert or display. In some examples, the contamination controller 140 outputs an instruction to the user to perform the one or more precautionary actions.

The contamination controller 140 may present the user with one or more additional options to further narrow the type of contamination. For example, if the user selected an animal contamination mode, the method 200 may include outputting one or more options to activate a type of animal contamination at 210. For example, the animal contamination mode options may include several different types of contaminations related to different animals, such as a bird, a snake, a dog, a cat, a rodent, a raccoon, a reptile, an amphibian, or the like. In other examples, other options for types of animal contaminations may be present. An option to select an unknown type of animal contamination may be included in the output. In some examples, the user may be presented with a list of the possible, or most likely, types of animal contamination.

In some examples, the options for the different types of animal contaminations may be outputted in an order based on a likelihood of the type of animal being present. For example, the likelihood of the type of animal being present may be based on location of the swimming pool or spa, local flora and fauna, geography, a user profile indicating what types of pets are nearby, recent events, and the like. Similarly, other types of information may be used for other types of contamination modes.

At 212, the contamination controller 140 may receive an input selecting the type of animal contamination. For example, the contamination controller 140 may receive a touch screen selection of an option to select a dog contamination from a user interface of the contamination controller 140 or from the mobile device 146.

Once the contamination controller 140 determines the type of animal contamination from the user input, the method 214 may include outputting one or more animal contamination mitigation options based on the type of contamination. At 216, the method 200 may include receiving an input selecting the type of animal contamination mitigation option.

Returning to 208, if the contamination controller 140 received an input selecting the human contamination option, then the method 200 proceeds to 222 to output options to activate the type of human contamination mode. Like the process for the animal contamination, the method 200 may further include receiving an input selecting the type of human contamination at 224. At 226, the method 200 may further include outputting one or more human contamination mitigation options based on the type of human contamination. Examples of the types of human contamination include, but are not limited to, formed stool contamination, diarrheal contamination, blood contamination, and vomit contamination. At 228, the method 200 may include receiving an input selecting the type of human contamination option.

Each type of contamination may provide a contamination mitigation option. The contamination mitigation option may provide a remedy for the type of contamination. A remedy may include one or more steps that may be taken by the contamination controller 140 or the user 160. The remedy may or may not cure the contamination. In some examples, a contamination mitigation option may be the same for more than one contamination mode. For example, a contamination mitigation option for mitigating a rodent contamination may be the same as for mitigating a reptile contamination. In other examples, the contamination mitigation options are different from each other.

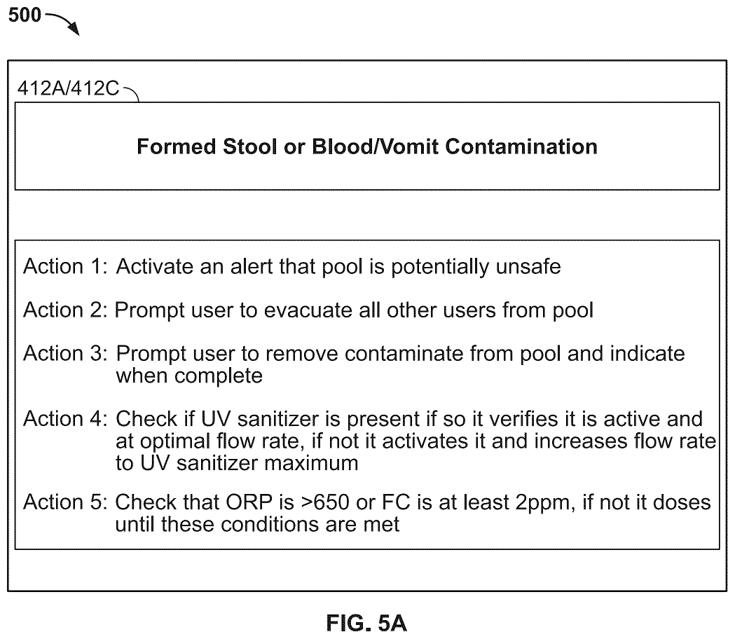

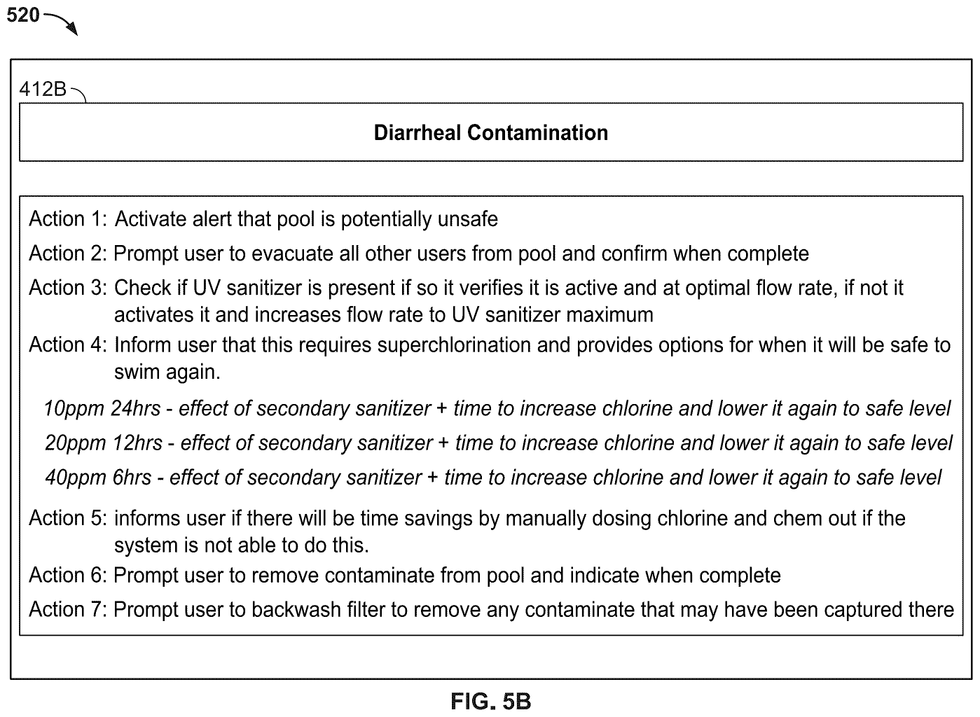

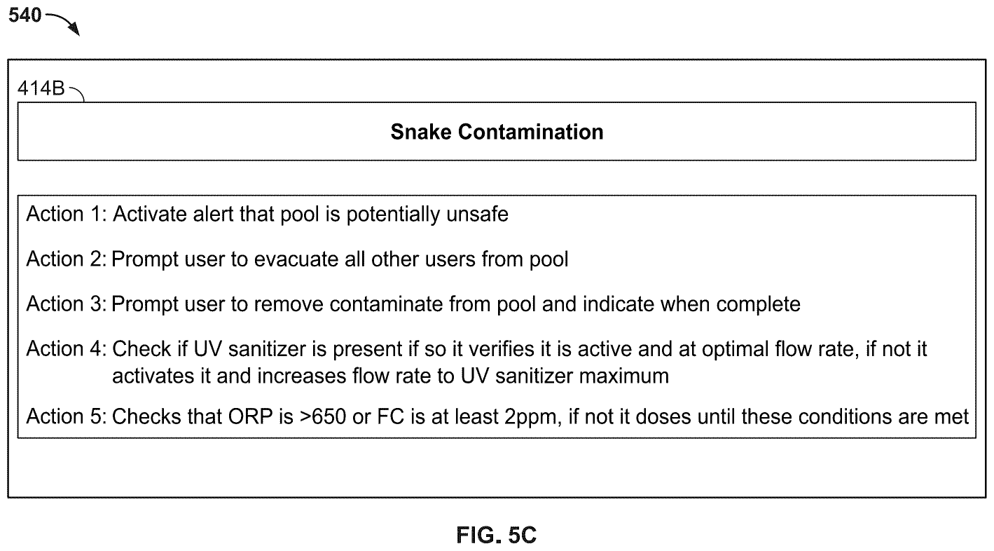

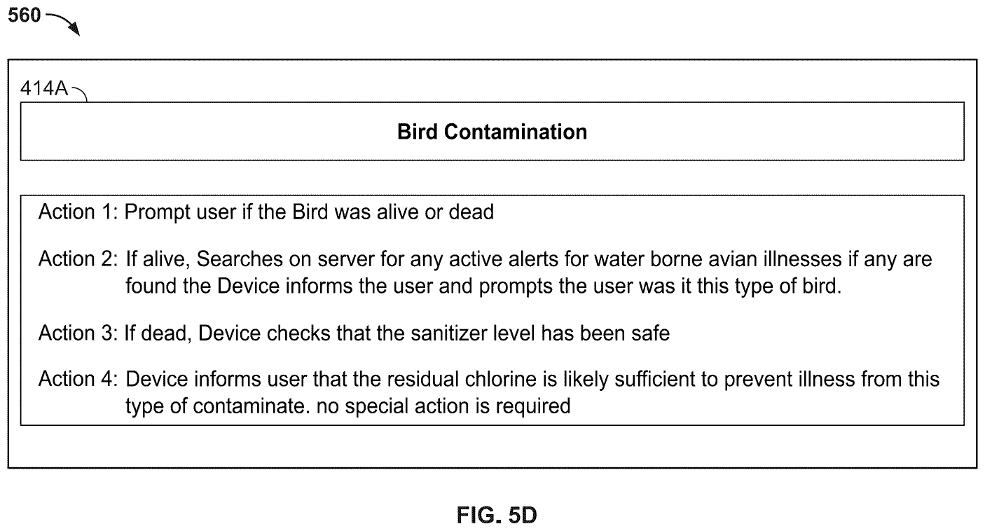

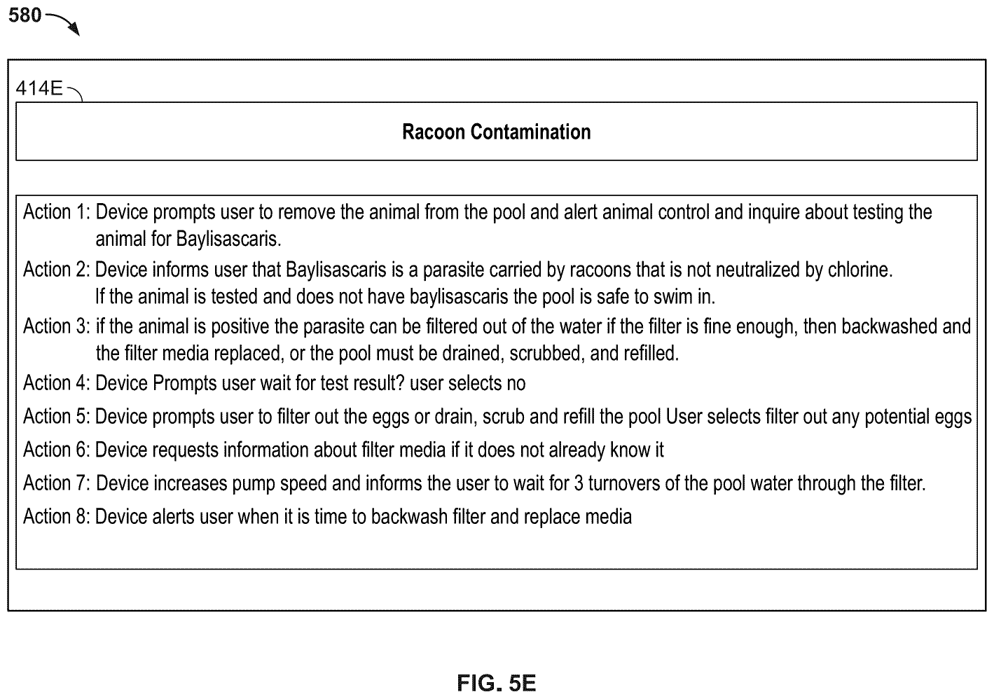

At 220, the method 200 may include outputting the instructions for the selected contamination mitigation option. For example, if the user selected human contamination at 208 and then selected blood or vomit contamination at 224, the method 200 may provide human contamination mitigation options including but not limited to those detailed below with respect to FIG. 5A. In examples where there is only one contamination mitigation option for the selected type of contamination, the method 200 may output only the single contamination mitigation option at 220. The method 200 may include receiving a confirmation that the single contamination mitigation option is going to be performed.

In some examples, the contamination controller 140 may perform every step in the selected contamination mitigation option. Alternatively, in other examples, the user may perform every step in the selected contamination mitigation option. In other examples, the contamination controller 140 may perform some of the steps of the contamination mitigation option while the user may perform other steps. In some examples, a contamination mitigation option may include requesting the services of a professional cleaner or repair person.

At 230, the method 200 may include receiving an input indicating that the contamination mitigation option has been performed. For example, the user or the contamination controller 140 may perform the one or more steps of the selected contamination mitigation option. The user may confirm that the one or more steps of the selected contamination mitigation option are completed by selecting an option indicating completion of the steps. If the method 200 receives an input that the contamination mitigation options are completed, then the method 200 may proceed to 232, and deactivate the contamination mode. In some examples, the method 200 further includes outputting a notification of deactivation of the contamination mode when the contamination mode is deactivated. For example, the contamination controller 140 may output an indication to the mobile device 146 that the contamination is cleared out and the swimming pool or spa can be used.

However, in examples where the user does not provide an input to the contamination controller 140, the method 200 may include performing one or more tests on the water at 234. In some examples, the test may be ordered by the contamination controller 140, the user, or both. In some examples, the contamination controller 140 may instruct one or more of the pool devices to perform a test, such as testing the pH of the water. In other examples, other tests may be performed or ordered such as testing various chemical levels or checking for contents in the swimming pool or spa water. In some examples, a test may be defined as checking for one or more contaminating objects in one or more images of the swimming pool or spa from a camera sensor.

In some examples, the method 200 may include performing the one or more tests at 234 regardless of the user indicating that the steps of the selected contamination mitigation option were complete. For example, a double check may be performed by checking the conditions of the water before deactivating the contamination mode.

At 236, if the tests are negative for contamination, the method 200 may proceed to 232 and deactivate the contamination mode. If one or more of the tests is positive or ambiguous for contamination, the method 200 may proceed to 204 to attempt the contamination mitigation process again. For example, if the contamination was incorrectly identified the first time, the contamination mitigation options presented to the user may have been incorrect. In this instance, the method 200 may repeat the steps. However, in some examples, the method 200 may output different contamination mitigation options, such as calling a professional cleaner or repair person to mitigate the contamination.

The example method 200 described in FIG. 2 includes two tiers of contamination: first a determination as to a general category defined by what overall type of contamination is present (for example, animal or human), and second a determination as to a more specific indication as to what type of the overall type of contamination is present (for example, in the case of an animal contamination: bird, rodent, dog, etc.). However, other examples are contemplated where only a single tier of contamination may be presented, which may be only an overall type of contamination, or the method 200 may go directly to the more specific types of contamination. In other examples, three or more tiers of contamination may be presented, wherein the third tier provides even more detailed options.

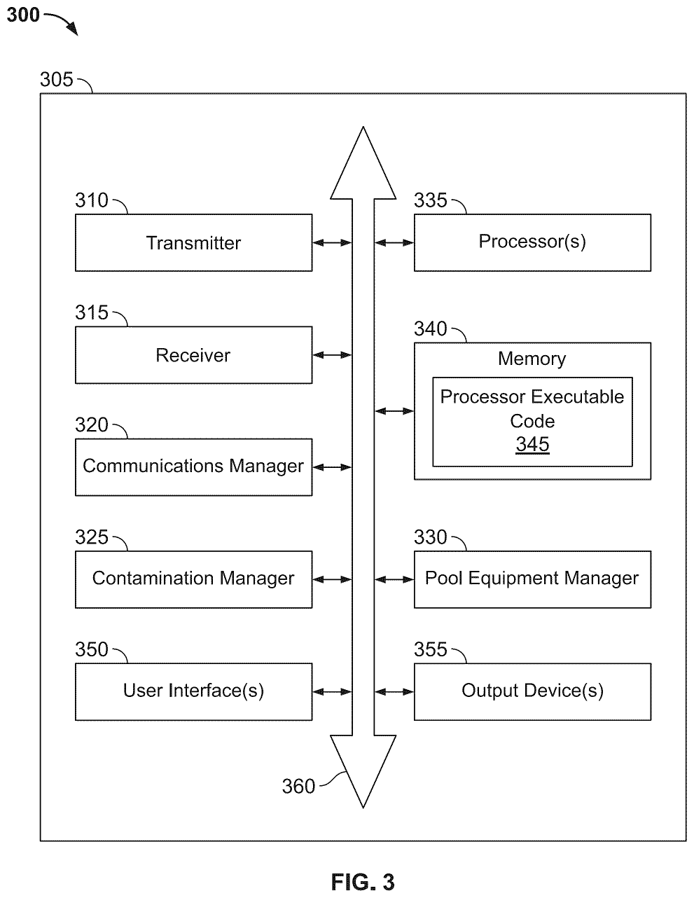

FIG. 3 is an example block diagram 300 of a device 305 that supports systems and methods for controlling swimming pool devices. The device 305 may be the contamination controller 140 as described herein. The device 305 may include a receiver 315, a transmitter 310, a communications manager 320, a contamination manager 325, a pool device manager 330, one or more user interfaces 350, and one or more output devices 355. The device 305, or one or more components of the device 305 (for example, the transmitter 310, the receiver 315, the communications manager 320, the contamination manager 325, the pool device manager 330, the one or more user interfaces 350, and the one or more output devices 355), may include at least one processor 335, which may be connected to least one memory 340, to, individually or collectively, support or enable the described techniques. Each of these components may be in communication with one another via one or more buses 360.

The receiver 315 may provide a means for receiving information such as packets, user data, control information, other signals, and any combination thereof associated with various information channels (for example, control channels, data channels, information channels, wired or wireless channels, and the like). Information may be passed on to other components of the device 305. The receiver 315 may utilize a single antenna or a set of multiple antennas. The receiver 315 may be designed to receive information related to the user 160 of the swimming pool 142 from one or more mobile devices 146. The receiver 315 may also be designed to receive an indication of a contamination, a selection of one or more contamination modes, a selection of one or more contamination mitigation options, and one or more indications of continued contamination or mitigated contamination. The receiver 315 may be designed to receive the information regarding the guidelines and/or recommended actions for mitigating the contamination in the swimming pool or spa 142.

The transmitter 310 may provide a means for transmitting signals generated by other components of the device 305. For example, the transmitter 310 may transmit information such as packets, user data, control information, other signals, or any combination thereof associated with various information channels (for example, control channels, data channels, information channels, wired or wireless channels, and the like). In some examples, the transmitter 310 may be co-located with a receiver 315 in a transceiver module. The transmitter 310 may utilize a single antenna or a set of multiple antennas. The transmitter 310 may also be designed to transmit signals and indications related to a detected contamination, a contamination alert, one or more contamination modes, one or more contamination mitigation options, a continued contamination, or a mitigated contamination.

The transmitter 310 may also be designed to transmit one or more signals to alert a user not to use the swimming pool or spa 142. The transmitter 310 may be further configured to transmit the ORP and pH values to the one or more user interfaces 350 to notify the user 160 whether these ORP and pH values are within ranges appropriate for swimming pool or spa use. Further, the transmitter 310 may be configured to transmit a request to the server 154 to provide recurring information regarding suggested guidelines and/or actions for mitigating contamination in the swimming pool or spa 142.

The transmitter 310, the receiver 315, the communications manager 320, the contamination manager 325, the pool device manager 330, the user interfaces 350, the output devices 355, or various combinations or components thereof may be examples of means for performing various aspects of a method to mitigate contamination of a swimming pool or spa as described herein. For example, the transmitter 310, the receiver 315, the communications manager 320, the contamination manager 325, and the pool device manager 330, the user interfaces 350, the output devices 355, or various combinations or components thereof may be capable of performing one or more of the functions described herein.

In some examples, the transmitter 310, the receiver 315, the communications manager 320, the contamination manager 325, and the pool device manager 330, the user interfaces 350, the output devices 355, or various combinations or components thereof may be implemented in hardware (for example, in communications management circuitry). The hardware may include at least one of a processor, a digital signal processor (DSP), a central processing unit (CPU), an application-specific integrated circuit (ASIC), a field-programmable gate array (FPGA) or other programmable logic device (PLD), a microcontroller, discrete gate or transistor logic, discrete hardware components, or any combination thereof configured as or otherwise supporting, individually or collectively, a means for performing the functions described in the present disclosure. In some examples, at least one processor and at least one memory in communication with the at least one processor may be configured to perform one or more of the functions described herein (for example, by one or more processors, individually or collectively, executing instructions stored in the at least one memory 340). In some examples, the one or more processors 335 may be provided in the form of a single-core processor, a dual-core processor, a quad-core processor, a hexa-core processor, an octa-core processor, a deca-core processor, or any other type of processor.

In some examples, the memory 340 may refer to a read access memory (RAM), read only memory (ROM), a flash memory, or any other type of memory. The memory 340 may be designed to store or otherwise save data related to one or more pool devices 102, different contamination types, contamination mitigation options, user profile data, historical data associated with the system 100, and the like.

Additionally, or alternatively, the transmitter 310, the receiver 315, the communications manager 320, the contamination manager 325, and the pool device manager 330, the user interfaces 350, the output devices 355, or various combinations or components thereof may be implemented in processor executable code 345 (for example, as communications management software or firmware) executed by the at least one processor 335 (for example, referred to as a processor-executable code 345). If implemented in code executed by at least one processor 335, the functions of the transmitter 310, the receiver 315, the communications manager 320, the contamination manager 325, and the pool device manager 330, the user interfaces 350, the output devices 355, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 320 may be configured to perform various operations (for example, receiving, obtaining, monitoring, outputting, transmitting) using or otherwise in cooperation with the transmitter 310, the receiver 315, or both. For example, the communications manager 320 may receive information from the receiver 315, send information to the transmitter 310, or be integrated in combination with the transmitter 310, the receiver 315, or both to obtain information, output information, or perform various other operations as described herein.

The communications manager 320 may support the techniques for mitigating contamination of a swimming pool or spa in accordance with examples disclosed herein. The communications manager 320 is capable of, configured to, or operable to support a means for receiving information associated with a contamination of the swimming pool or spa from at least a mobile device. The communications manager 320 is further capable of, configured to, or operable to support a means for transmitting information associated with a contamination of the swimming pool or spa from at least a mobile device.

In some examples, the communications manager 320 is further capable of, configured to, or operable to support a means for receiving a first input at a user interface to activate a contamination mode for the swimming pool or spa. In additional examples, the communications manager 320 is also capable of, configured to, or operable to support a means for outputting an indication of one or more contamination mitigation options at the user interface in association with receiving the first input to activate the contamination mode. In some examples, the communications manager 320 is further capable of, configured to, or operable to support a means for receiving a second input at the user interface to select a contamination mitigation option from the one or more contamination mitigation options.

The contamination manager 325 may support the techniques and/or recommended actions for mitigating contamination in a swimming pool or spa in accordance with examples as disclosed herein. The contamination manager 325 is capable of, configured to, or operable to support a means for receiving a first input at a user interface to activate a contamination mode for the swimming pool or spa. The contamination manager 325 is further capable of, configured to, or operable to support a means for outputting an indication of one or more contamination mitigation options at the user interface in association with receiving the first input to activate the contamination mode. The contamination manager 325 is further capable of, configured to, or operable to support a means for receiving a second input at the user interface to select a contamination mitigation option from the one or more contamination mitigation options. The contamination manager 325 is further capable of, configured to, or operable to support a means for performing one or more contamination mitigation actions associated with the selected contamination mitigation option.

The contamination manager 325 may be designed to activate a human contamination mode based at least in part on receiving the first input. In other examples, the contamination manager 325 may also be designed to activate the animal contamination mode based at least in part on receiving the first input. In other examples, the contamination manager 325 may also be designed to output an alert that the swimming pool or spa an alert that the water of the swimming pool or spa may be contaminated, or that one or more pool chemical levels may be out of normal range.

The pool device manager 330 may support the techniques for controlling the pool device in accordance with examples as disclosed herein. The pool device manager 330 is capable of, configured to, or operable to support a means for performing one or more contamination mitigation actions associated with the selected contamination mitigation option. For example, the pool device manager 330 is capable of, configured to, or operable to support a means for determining whether water in the swimming pool or spa has been sanitized.

The pool device manager 330 is further capable of, configured to, or operable to support a means for performing an action associated with the contamination mitigation option. In some examples, the pool device may perform the action associated with the contamination mitigation option, which may be instructed by the pool device manager 330 via the contamination controller 140. In some instances, the contamination mitigation option may include setting a flow rate of a UV sanitizer system to a first flow rate when the water in the swimming pool or spa has been sanitized and setting the flow rate of the UV sanitizer system to a second flow rate when the water in the swimming pool or spa has not been sanitized. In some examples, the second flow rate may be slower than the first flow rate.

In other examples, the contamination manager 325 may receive an input at the user interface to activate a chlorination contamination mitigation option. The pool device manager 330 may output instructions for at least one chlorination dosage paired with at least one time frame. Each pair may be associated with a respective time duration indicating when the swimming pool or spa water may be clean (e.g., decontaminated, cleaned, or neutralized), or that one or more pool chemical levels may be within normal range.

In some instances, the contamination manager 325 may determining that an oxidation-reduction potential associated with the swimming pool or spa is outside a standard range (for example, greater than 650 millivolts (mV), and may instruct the pool device manager 330 to dose the water in the swimming pool or spa until the oxidation-reduction potential is within the standard range.

In another example, the contamination manager 325 may determine a pH level of water in the swimming pool or spa and may base the contamination mitigation options on the pH level. The contamination manager 325 may select a dosage of an additional sanitizer to add to the water in the swimming pool or spa based at least in part on the determined pH level.

In yet another example, the contamination manager 325 may determine a level of at least one chemical in the swimming pool or spa and may base the contamination mitigation options on the chemical level. The contamination manager 325 may select a dosage of an additional sanitizer to add to the water in the swimming pool or spa based at least in part on the level of at the least one chemical in the water of the swimming pool or spa.

The contamination mitigation manager 325 may receive a third input associated with completion of the one or more contamination mitigation actions and deactivate the contamination mode based at least in part on receiving the third input.

The one or more user interfaces 350 may manage input and output signals for the device 305. The one or more user interfaces 350 may also manage peripherals not integrated into the device 305. In some cases, the one or more user interfaces 350 may represent a physical connection or port to an external peripheral. In some cases, the one or more user interfaces 350 may utilize an operating system such as iOS®, ANDROID®, MS-DOS®, MS-WINDOWS®, OS/2®, UNIX®, LINUX®, or another known operating system. Additionally, or alternatively, the one or more user interfaces 350 may represent or interact with a modem, a keyboard, a mouse, a touchscreen, or a similar device. In some cases, the one or more user interfaces 350 may be implemented as part of one or more processors, such as the at least one processor 335. In some cases, a user may interact with the device 305 via the one or more user interfaces 350 or via hardware components controlled by the one or more user interfaces 350.

The one or more user interfaces 350 may be configured to receive a first input to activate a contamination mode associated with a contamination of the swimming pool or spa. The one or more user interfaces 350 may also be configured to output an indication of one or more contamination mitigation options. Additionally, the one or more user interfaces 350 may be configured to receive a second input to select at least one of the one or more contamination mitigation options.

Some examples of the device 305 omit a user interface 350, and instead the device 305 provides signals to an external device (e.g., a mobile device) to provide functions of the user interfaces 350.

The user interfaces 350 are further capable of, configured to, or operable to support a means for receiving a first input to activate a contamination mode for the swimming pool or spa, outputting an indication of one or more contamination mitigation options in association with receiving the first input to activate the contamination mode, and receiving a second input to select a contamination mitigation option from the one or more contamination mitigation options. The user interfaces 350 are further capable of, configured to, or operable to support a means for outputting an alert that the pool or spa water may be contaminated, or that one or more pool chemical levels may be out of normal range. The user interfaces 350 are further capable of, configured to, or operable to support a means for receiving an input at the user interface to activate a chlorination contamination mitigation option. The user interfaces 350 are further capable of, configured to, or operable to support a means for receiving a third input associated with completion of the one or more contamination mitigation actions.

The one or more output devices 355 may include a light emitting diode (LED) display, a liquid crystal display (LCD), an organic LED (OLED) display, or another known display. In other examples, the one or more output devices 355 may be provided in the form of one or more speakers or one or more motors to create haptic feedback. However, some examples of the device 305 do not include an output device 355, and instead the device 305 provides signals to an external device, such as a mobile device, to provide functions of the output devices 355.

The one or more output devices 355 are further capable of, configured to, or operable to support a means for outputting an indication of one or more contamination mitigation options at the user interface in association with receiving the first input to activate the contamination mode. The one or more output devices 355 are further capable of, configured to, or operable to support a means for outputting an alert that the water of the swimming pool or spa may be contaminated, or that one or more pool chemical levels may be out of normal range.

The one or more output devices 355 are further capable of, configured to, or operable to support a means for outputting instructions for at least one chlorination dosage paired with at least one time frame. The one or more output devices 355 are further capable of, configured to, or operable to support a means for outputting an indication of a deactivation of the contamination mode.

By including or configuring the transmitter 310, the receiver 315, the communications manager 320, the contamination manager 325, the pool device manager 330, the user interfaces 350, and the output devices 355 in accordance with examples as described herein, the device 305 (for example, at least one processor controlling or otherwise coupled with the transmitter 310, the receiver 315, the communications manager 320, the contamination manager 325, the pool device manager 330, the user interfaces 350, the output devices 355, or a combination thereof) may support techniques for mitigating contamination in a swimming pool or spa.

The device 305 may be able to download, store, or execute software having computer-executable instructions. The software may include one or more modules. The one or more modules may include, for example, algorithms to monitor or store the measurements or other data received from one or more of the system components such as the sensors, valves, tank, or pumps, or may monitor or store real-time and historic flow patterns and usage data. The device 305, via the one or more modules, may also perform calculations or other data analysis or modeling processes to determine various outcomes. The outcomes may include, for example, turning one or more of the components of the system 100 on or off at certain times or intervals or placing one or more of the system components in standby mode.

The contamination manager 325 may be electronically connected to the one or more user interfaces 350 and other components of the system 100, including the various sensors, valves, tank, and pump via one or more wires or may be electronically connected via a communications network. The communications network may be a wireless network such as a personal area network (PAN) or LAN, a cellular network, or the Internet, or any other type of network.

In some examples, the contamination controller 140 may be able to self-diagnose or troubleshoot problems that arise without input from one of the various components or a user. Artificial intelligence or machine learning may be used to learn different patterns of usage to predict future behavior.

In some instances, the one or more modules may include a training module that may be designed to execute instructions related to one or more data analysis and modeling processes. In some examples, the training module may generate and iteratively train itself to provide dynamic data analysis and outcomes, and the advanced analytics may be used to perform system or component diagnostics, generate alerts, notifications, or action items, provide customized recommendations according to user or service provider settings or preferences, and similar processes.

In some embodiments, one or more metrics or characteristics (for example, historic water usage data, system pressure, TDS concentration, or water flow rates) may be used as parameters in one or more processes to iteratively train a training model or a plurality of machine learning training models. Processes for “iteratively training the machine learning training model” may include machine learning processes, artificial intelligence processes, and other similar advanced machine learning processes. In various embodiments, the iteratively trained machine learning model(s) may be designed to perform various advanced data analysis and modeling processes. In some embodiments, these processes may be performed by multiple machine learning models, or multiple aspects of a single machine learning model (for example, an ensemble model), or a combination thereof. In one non-limiting example, the machine learning training model(s) may be designed to generate, train, and execute a plurality of nodes, neural networks, gradient boosting algorithms, mutual information classifiers, random forest classifications, and other machine learning and artificial intelligence-related algorithms. The system and processes described herein may include different or additional details, data, measurements, parameters, metrics, or characteristics than those described herein.

The device 305 may be Bluetooth enabled and have Internet of Things (IoT) connectivity. The water treatment system components, that is, the pool device (the sensors, valves, feeder, pump, etc.) may be IoT-enabled or communicatively connected smart components.

In some examples, the at least one processor 335 may be coupled with one or more memories 340 and may be configured to individually or collectively execute the processor-executable code 345 to cause the swimming pool or spa control device to receive a first input at a user interface to activate a contamination mode associated with a contamination of the swimming pool or spa, output an indication of one or more contamination mitigation options at the user interface, receive a second input at the user interface to select at least one of the one or more contamination mitigation options, perform one or more contamination mitigation actions associated with the at least one selected contamination mitigation option, and deactivate the contamination mode based at least in part on the performance of the one or more contamination mitigation actions.

The memory 340 may be configured to store or save the one or more actions performed for mitigating the contamination, the information regarding the latest guidelines received from the server 154, and any such information.

The device 305 may work in conjunction with, or independent from, one or more local controllers associated with one or more pool components as disclosed herein. Alternatively, one or more local controllers associated with the pool components may work in conjunction with, or independent from, the device 305 to effectuate the operational modes and other methods described herein.

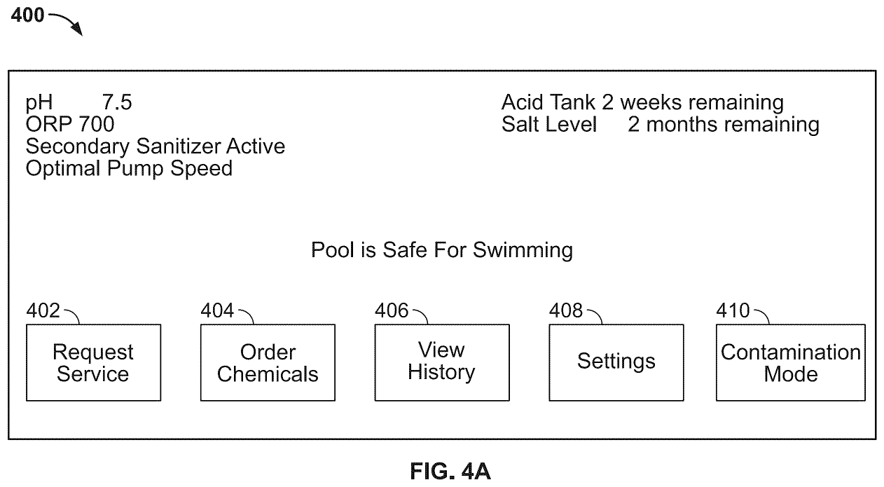

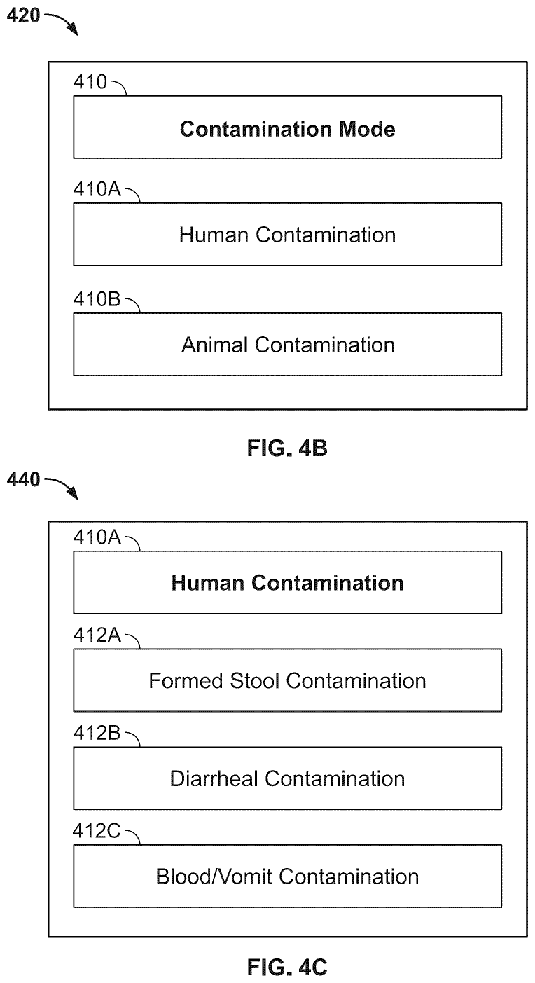

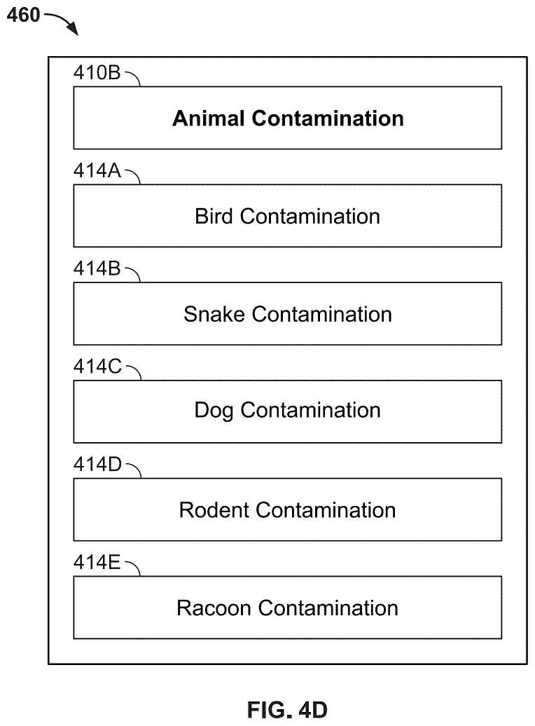

Referring now to FIG. 4A, a graphical user interface 400 of the contamination controller 140 of the swimming pool or spa 142 for mitigating contamination in the swimming pool or spa 142 is provided. In some examples, the graphical user interface 400 may be output at one or more output devices 355 or one or more user interfaces 350. The graphical user interface 400 may depict a measured or determined current value of pH and ORP as 7.5 and 700, respectively, as received from a flow cell connected to the contamination controller 140. The graphical user interface 400 may inform the user 160 of general alerts. For example, the graphical user interface 400 may inform the user 160 that a secondary sanitizer is “active” and that a pump is connected to the swimming pool or spa 142 and is running at a predetermined or set speed.

Further, the graphical user interface 400 may inform the user 160 of the levels of acid contained in an acid tank. Additionally, the graphical user interface 400 may suggest when to refill an acid tank by providing an estimate of how much acid is currently in the acid tank. Similarly, the graphical user interface 400 may suggest when to refill a salt tank by providing an estimate of how much salt remains in the salt tank. Further, the graphical user interface 400 may display a current contamination status of the swimming pool or spa 142. Such contamination status may include but is not limited to the pool or spa water having a contamination, that one or more pool chemical levels may be out of normal range, that the pool or spa water has not been indicated to be contaminated, or that one or more pool chemical levels may be within a normal range. For example, when the user 160 selects the “contamination mode” 410 option as explained above in FIG. 2, the graphical user interface 400 may automatically display a message indicating to the user 160 that the water of the swimming pool or spa may be contaminated, or that one or more pool chemical levels may be out of normal range.

In some instances, the graphical user interface 400 may display a “request service” option 402 in which the user 160 may place a request for a variety of services including, but not limited to, servicing the swimming pool or spa 142. The graphical user interface 400 may also show an “order chemicals” option 404, wherein the user 160 may place a request for ordering chemicals for sanitizing or dosing the swimming pool or spa 142. In other instances, the graphical user interface 400 may also show a “view history” option 406 that enables the user 160 to view their service request or order history.

In some instances, the graphical user interface 400 may display a “settings” option 408 that may enable the user 160 to change or modify any setting related to the contamination controller 140. Such settings may include, but are not limited to, changing the format, size, or color of any information or options being displayed at the graphical user interface 400.

In some instances, the user 160 may manually deactivate the contamination mode by providing an input at the graphical user interface 400 or the contamination controller 140 to automatically deactivate the contamination mode. In this instance, the user 160 may manually deactivate the contamination mode by indicating that the selected contamination option has been mitigated. The selected contamination option may be mitigated when the user 160 or the contamination controller 140 performs the one or more actions as described herein. In this instance, the contamination controller 140 may transmit a notification to the mobile device 146 of the user 160 indicating when the water of the swimming pool or spa may be clean (e.g., decontaminated, cleaned, or neutralized), or that one or more pool chemical levels may be within normal range.

In some instances, the contamination controller 140 may communicate with the server 154 to obtain an up-to-date list of contamination mitigation actions for the selected contamination option. In this instance, the contamination controller 140 may display a latest list of actions to be performed for the selected contamination option. For example, a government agency may list (for example, on a website) the latest types of contamination that may be present in swimming pools or spas along with a suggested list of corresponding contamination mitigation actions to be performed. In this example, the contamination controller 140 may receive the information from the server 154 and automatically update the graphical user interface 400 to display a contamination option along with the corresponding list of contamination mitigation actions.

In another instance, a government agency may list or publish (on their website) or add the latest contamination mitigation actions to be performed for mitigating a known type of contamination. In this instance, the contamination controller 140 may receive the contamination mitigation actions from the server 154 and automatically update the graphical user interface 400 to display the latest contamination mitigation actions for the known type of contamination option at the graphical user interface 400.

In some examples, the contamination controller 140 may determine a level of pH or one or more chemicals of the swimming pool or spa 142 after receiving a selection of the type of contamination. The contamination controller 140 may determine an actual level of pH and other chemicals (such as chlorine) in the swimming pool or spa 142 using pH sensors after a contamination option is selected at the graphical user interface 400. Determining a current pH level may help inform whether dosing of any sanitizer or other chemical may be used to mitigate the contamination in the swimming pool or spa 142.

FIGS. 4B-4D illustrate additional examples of contamination options displayed at graphical user interfaces 420, 440, and 460, respectively. In some examples, the graphical user interfaces 420, 440, and 460 may be output at one or more output devices 355 or one or more user interfaces 350.

For example, when contamination is detected in the swimming pool or spa 142, the user 160 may use the graphical user interface 400 associated with the contamination controller 140. At the graphical user interface 400, the user 160 may provide an input to activate a contamination mode for the swimming pool or spa 142. Thereby, the graphical user interface 400 may receive the input from the user 160 to activate the contamination mode. The graphical user interface 400 associated with the contamination controller 140 may display a button or an option of “Contamination Mode” 410 (as shown in FIGS. 4A and 4B), among other options. By tapping or long pressing this option or button 410, the user 160 may activate the contamination mode. By activating the contamination mode, an alert may be transmitted to the mobile device 146 of the user 160 of the swimming pool or spa 142 to refrain from using the swimming pool or spa 142.

By activating the contamination mode at the graphical user interface 400 associated with the contamination controller 140, the contamination controller 140 may provide one or more contamination options at the user interface, as shown in the example graphical user interface 420 in FIG. 4B. The one or more contamination options may correspond to a human contamination option or an animal contamination option. Under the “Contamination Mode” 410, two contamination options are provided, including “Human Contamination” 410A and “Animal Contamination” 410B.

The user 160 may select the “Human Contamination” 410A option or the “Animal Contamination” 410B option at the graphical user interface 420. As a result of selecting the “Human Contamination” option 410A, one or more human contamination options are displayed. In the example of FIG. 4, an instance of the graphical user interface 440 associated with the contamination controller 140 is provided. In FIG. 4C, under the “Human Contamination” 410A option, three human contamination options are provided including, “Formed Stool Contamination” 412A, “Diarrheal Contamination” 412B, and “Blood/Vomit Contamination” 412C.

As a result of selecting the “Animal Contamination” 410B option in FIG. 4B, one or more animal contamination options may be displayed at the graphical user interface 460 associated with the contamination controller 140 in FIG. 4D. Under the “Animal Contamination” 410B option, five human contamination options are provided including, “Bird Contamination” 414A, “Snake Contamination” 414B, “Dog Contamination” 414C, “Rodent Contamination” 414D, and “Raccoon Contamination” 414E.

Turning to FIG. 5A, an example graphical user interface 500 is provided, which provides a formed stool or blood/vomit contamination mitigation option. The contamination controller 140 may perform one or more actions based on the selected contamination option to mitigate the contamination. When the user 160 selects “Formed Stool Contamination” 412A or the “Blood/Vomit Contamination” 412C as shown in FIG. 4C, the contamination controller 140 may perform one or more actions. The actions provided in FIG. 5A may include, but are not limited to, activating an alert that the water of the swimming pool or spa may be contaminated, or that one or more pool chemical levels may be out of normal range, prompting the user 160 to evacuate all other users from the swimming pool or spa 142, prompting the user 160 to remove the contaminant from the swimming pool or spa 142, and indicating when the removal of the contamination may be complete. The contamination controller 140 may also perform actions such as verifying if the water has been sanitized by the UV sanitizer system. If the mitigation controller verifies that the water has been sanitized by the UV sanitation system, the contamination controller 140 may verify whether the UV sanitizer system is active and at first flow rate. If the UV sanitizer system is not at a first flow rate, the contamination controller 140 may adjust the flow rate of the UV sanitizer system to a second flow rate. The first flow rate may be set based on the size of the swimming pool or spa and the type of UV lamp in the UV sanitizer system. The second flow rate may be a maximum possible flow rate based on the size of the swimming pool or spa, type of UV lamp in the UV sanitizer system, and type of contamination present in the swimming pool or spa 142.

The contamination controller 140 may also determine whether the value of the ORP is greater than 650 or, if the flow cell is at least 2 parts per million (ppm), if not, the contamination controller 140 may dose the water of the swimming pool or spa 142 until these conditions are met.

Turning to FIG. 5B, an example graphical user interface 520 is provided, which provides a formed stool or blood/vomit contamination mitigation option. In some examples, when the user 160 selects “Diarrheal Contamination” 412B as shown in FIG. 4C, the contamination controller 140 performs one or more actions as shown in FIG. 5B including, but not limited to, activating an alert that the water of the swimming pool or spa 142 may be contaminated, or that one or more pool chemical levels may be out of normal range, prompting the user 160 to evacuate one or more users from the swimming pool or spa 142, and confirming when complete.

In some examples, the contamination controller 140 may verify whether the water of the pool or spa 142 has been sanitized by the UV sanitizer system. If the mitigation controller determines that the water of the pool or spa 142 has been sanitized by the UV sanitizer system, the contamination controller 140 verifies if the sanitizer is active and at first flow rate. If the UV sanitizer system is not at a first flow rate, the contamination controller 140 may adjust the flow rate of the UV sanitizer system to a second flow rate. The first flow rate may be based on the size of the swimming pool or spa and the type of UV lamp in the UV sanitizer system. The second flow rate may be a maximum possible flow rate based on the size of the swimming pool or spa, type of UV lamp in the UV sanitizer system, and type of contamination present in the swimming pool or spa. The contamination controller 140 may also perform actions such as informing the user 160 that super-chlorination for the contamination of the swimming pool or spa is recommended. In this instance, the UV sanitizer system may be set to a second flow rate and the graphical user interface 520 may receive an input to activate a chlorination contamination mitigation option and outputting instructions for at least one chlorination dosage paired with at least one time frame, wherein each of the at least one chlorination dosage and the paired at least one time frame are associated with a respective time duration indicating when the water of the swimming pool or spa may be clean (e.g., decontaminated, cleaned, or neutralized), or that one or more pool chemical levels may be within normal range. In some examples, the salt chlorine generator 134 may be instructed to chlorinate the water based on the contamination mitigation options.

The following are example options for when the water of the swimming pool or spa may be clean (e.g., decontaminated, cleaned, or neutralized), or that one or more pool chemical levels may be within normal range, and may be used again:
10 ppm 24 hours: effect of secondary sanitizer plus time to increase chlorine and then lower it again to a normal level.
20 ppm 12 hours: effect of secondary sanitizer plus time to increase chlorine and then lower it again to a normal level.
40 ppm 6 hours: effect of secondary sanitizer plus time to increase chlorine and then lower it again to a normal level.

In some examples, the contamination controller 140 may inform the user 160 if the pool water may be cleaned (e.g., decontaminated, cleaned, or neutralized) in a more efficient or effective way via manual dosing of chlorine or other chemicals if the swimming pool or spa 142 is not able automatically implement one or more mitigation measures in a timely manner. The contamination controller 140 may also prompt the user 160 to remove contamination from the swimming pool or spa 142 and indicate when it is complete. In some instances, the contamination controller 140 may prompt the user 160 to backwash a filter to remove any contamination that may have been captured there and/or effectuate a number of other mitigation or decontamination measures as described herein.

Turning to FIG. 5C, an example graphical user interface 540 is provided, which provides a snake contamination mitigation option. In some instances, when the user 160 selects the “Snake Contamination” 414B as shown in FIG. 4D, the contamination controller 140 may perform one or more actions as shown in FIG. 5C including, but not limited to, activating an alert that the water of the swimming pool or spa may be contaminated, or that one or more pool chemical levels may be out of normal range, prompting the user 160 to evacuate one or more other users from the swimming pool or spa 142 and confirm when complete, and prompting the user 160 to remove the contaminate from the swimming pool or spa 142 and indicating when complete.

The contamination controller 140 may also perform actions such as checking if the water has been sanitized by the UV sanitizer system. If so, the contamination controller 140 may verify if the sanitizer is active and operating at first flow rate. If the UV sanitizer system is not operating at a first flow rate, the contamination controller 140 may adjust the flow rate of the UV sanitizer system to a second flow rate. The first flow rate may be defined by a flow rate based on the size of the swimming pool or spa and the type of UV lamp in the UV sanitizer system. The second flow rate may be defined by a maximum possible flow rate based on the size of the swimming pool or spa, type of UV lamp in the UV sanitizer system, and type of contamination present in the swimming pool or spa. The contamination controller 140 may also determine that the ORP value is >650 or the flow cell is at least 2 ppm. If not, the contamination controller 140 doses until these conditions are met.

FIG. 5D provides an example graphical user interface 560, which shows a bird contamination mitigation option. In some instances, when the user 160 selects “Bird Contamination” 414A as shown in FIG. 4D, the contamination controller 140 may performs one or more actions as shown in FIG. 5D. The actions may include, but are not limited to, prompting the user 160 if the bird is alive or deceased. If the bird is alive, the contamination controller 140 may search on the server 154 for any active alerts for the water borne avian illnesses. If water borne avian illnesses are found, the contamination controller 140 may inform the user 160 of the water borne avian illness and prompt the user 160 to identify the type of bird. If the bird is deceased, the contamination controller 140 may verify that the water in the pool or spa is clean (e.g., decontaminated, cleaned, or neutralized), or that one or more pool chemical levels may be within normal range.

The contamination controller 140 may inform the user 160 that the residual chlorine is likely sufficient to prevent illness from this type of contamination. Thus, no contamination mitigation action(s) may be implemented or suggested.

FIG. 5E provides an example graphical user interface 580, which shows a raccoon contamination mitigation option. In some instances, when the user 160 selects the “Raccoon Contamination” 414E as shown in FIG. 4D, the contamination controller 140 may perform one or more actions as shown in FIG. 5E. These actions may include, but are not limited to, prompts for the user 160 to remove the animal from the swimming pool or spa 142 and/or an alert for animal control to inquire about testing the animal for one or more parasites or diseases, such as Baylisascaris. The contamination controller 140 may inform the user 160 that Baylisascaris is a parasite carried by raccoons that is not neutralized by chlorine. If the animal is tested and does not have Baylisascaris, the swimming pool or spa 142 may be clean (e.g., decontaminated, cleaned, or neutralized), or that one or more pool chemical levels may be within normal range.

The contamination controller 140 may also inform the user of one or more contamination mitigation actions to take if the animal tests positive for Baylisascaris. These contamination mitigation actions may include, but are not limited to, filtering the parasite out of the water of the swimming pool or spa 142, backwashing the water of the swimming pool or spa 142, and replacing the filter media. In another example, it may be recommended that the swimming pool or spa 142 be drained, scrubbed, and refilled with clean water. The contamination controller 140 may prompt the user 160 to wait for the test result. If the user 160 selects “no,” the contamination controller 140 may prompt the user 160 to filter out any animal eggs or drain, scrub, and refill the swimming pool or spa 142. If the user 160 chooses to filter out any animal eggs, the contamination controller 140 may request information regarding filter media if the contamination controller 140 does not already have this information available or stored. In some instances, the contamination controller 140 may further increase the pump's speed or flow rate and inform the user 160 to wait for a certain number of turnovers (e.g., 2, 3, or more) of the water of the swimming pool or spa 142 through the filter. The contamination controller 140 may alert the user 160 when it is time to backwash filter and replace the media.

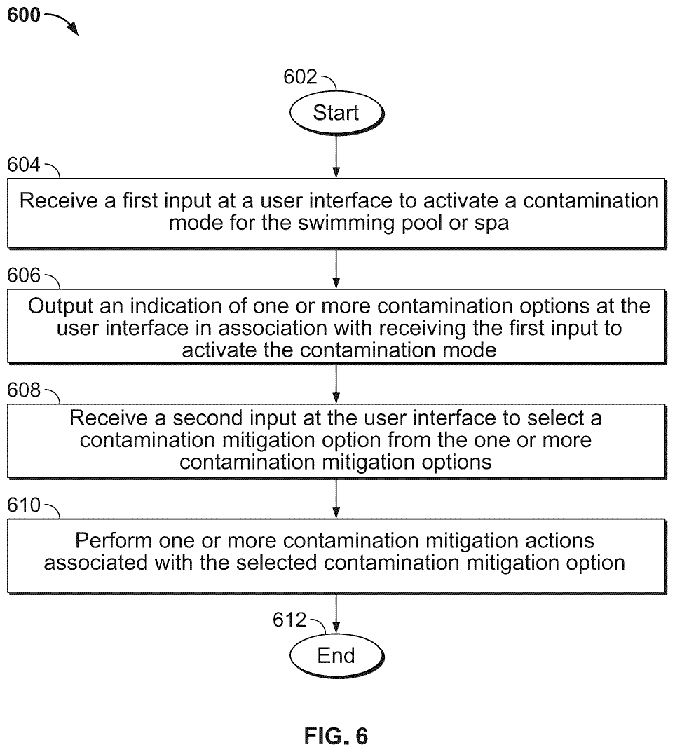

Referring now to FIG. 6, an example method 600 for mitigating contamination in a swimming pool or spa is provided. The operations of the method 600 may be implemented by the system 100 or its components as described herein. For example, some or all of the operations of the method 600 may be performed by the contamination controller 140, the server 154, the network 150, the mobile device 146, or a pool device 102 as described with reference to FIGS. 1-3. In some examples, the contamination controller 140, the network 150, the mobile device 146, or the pool device 102 may execute a set of instructions to control the functional elements of the contamination controller 140, the network 150, the mobile device 146, or the pool device 102 to perform the described functions. Additionally, or alternatively, the contamination controller 140, the network 150, the mobile device 146, or the pool device 102 may perform aspects of the described functions using special-purpose hardware. In other examples, other components of the system 100 may perform aspects of the described functions.

The method 600 starts at 602. At 604, the mitigation controller, using one or more processors, may receive a first input at a user interface to activate a contamination mode for the swimming pool or spa. The first input at the user interface to activate the contamination mode may be associated with a human contamination mode. The human contamination mode may be activated based at least in part on receiving the first input. Additionally, the animal contamination mode may be activated based at least in part on receiving the first input.

At 606, an indication of one or more contamination mitigation options may be output and/or displayed at the user interface in association with receiving the first input to activate the contamination mode. The one or more contamination mitigation options may include one or more human contamination mitigation options associated with the human contamination mode. Additionally, the one or more contamination mitigation options may be provided in the form of one or more animal contamination mitigation options associated with the animal contamination mode.

At 608, the mitigation controller, using one or more processors, may receive a second input at the user interface to select a contamination mitigation option from the one or more contamination mitigation options.

At 610, a user or one or more pool devices may perform one or more contamination mitigation actions associated with the selected contamination mitigation option. The one or more memories of the mitigation controller may store or save the one or more contamination mitigation actions associated with the selected contamination mitigation option. Performing the one or more contamination mitigation actions associated with the selected contamination mitigation option may further include outputting an alert that the water of the swimming pool or spa may be contaminated, or that one or more pool chemical levels may be out of normal range.

The transmitter may transmit one or more signals to the user interface notifying the user the water of the swimming pool or spa may be contaminated, or that one or more pool chemical levels may be out of normal range.

The method 600 ends at 612.

The mitigation controller, using the one or more processors, may determine that the water in the swimming pool or spa has been sanitized, determine that a UV sanitizer system is active, and set a flow rate of the UV sanitizer to a first flow rate. If the mitigation controller verifies that the swimming pool or spa water has not been sanitized, the mitigation controller may activate the UV sanitizer system and set the flow rate of the UV sanitizer system to a second flow rate. The first flow rate and second flow rate may be determined as disclosed in the discussion of FIG. 2 above.

Setting the flow rate of the UV sanitizer system to the second flow rate may cause the mitigation controller to receive an input at the user interface to activate a chlorination contamination mitigation option and output instructions for at least one chlorination dosage paired with at least one time frame. Each of the at least one chlorination dosage and the paired, at least one time frame, are associated with a respective time duration indicating when the water of the swimming pool or spa may be clean (e.g., decontaminated, cleaned, or neutralized), or that one or more pool chemical levels may be within normal range.

Performing the one or more contamination mitigation actions associated with the selected contamination mitigation may also include causing the mitigation controller to determine that an oxidation-reduction potential associated with the swimming pool or spa is not within a standard range and dosing the swimming pool or spa water until the oxidation-reduction potential is within the standard range.

The mitigation controller may determine a pH level of water in the swimming pool or spa. In this instance, the one or more contamination mitigation options may be based on the determined pH level. Further, the mitigation controller may select a dosage of an additional sanitizer to add to the water in the swimming pool or spa based at least in part on the determined pH level.

The mitigation controller may determine a level of at least one chemical in the swimming pool or spa. The one or more contamination mitigation options may be based at least in part on the one or more chemical level. Further, the mitigation controller may select a dosage of an additional sanitizer to add to water of the swimming pool or spa based on the determined level of the at least one chemical in the water of the swimming pool or spa.

The mitigation controller may receive a third input associated with completion of the one or more contamination mitigation actions and deactivate the contamination mode based at least in part on receiving the third input.

It is to be understood that one or more of the values associated with the methods of FIG. 2 and FIG. 6 may also be measured at different time intervals. The one or more values described with reference to methods disclosed herein may be measured on demand, manually implemented, or at predetermined time intervals (for example, continuously, once a second, once a minute, once a day, once a week, once a month, etc.). Further, it is to be understood that the one or more of the values associated with the methods disclosed herein may be measured more than once. For example, a first measurement of the one or more values may be carried out at a first time period followed by a second measurement carried out at a second time period, where the amount of time that elapses between the first time period and the second time period is determined by the predetermined time interval or another predetermined operational condition. In each instance, such measurements may be carried out by one or more systems provided with the system 100 and then received and stored by a controller (for example, the contamination controller 140 of FIG. 1 or the device 305 of FIG. 3, or any local controllers of the pool device of FIG. 1).

In addition, the predetermined values, thresholds, ranges, and other information described with reference to the methods disclosed herein may be manually implemented or otherwise input into the system 100. For example, the predetermined values and predetermined ranges may be manually input into a user interface of a controller (for example, the contamination controller 140 or the local controllers of the pool components of the 100 of FIG. 1), provided to the controller via a user device that may be in communication with the controller or otherwise associated with and retained by the contamination controller 140.

In some instances, a lookup table of predetermined values, thresholds, ranges, and other information may be stored by a controller (for example, the contamination controller 140 or any local controllers of the pool device of the system 100 of FIG. 1), and the controller may determine an appropriate action based on one or more of the variables discussed herein. In addition, the controller may include pre-stored lookup tables. Furthermore, the contamination controller 140 may be in communication with a network (for example, a cloud network) and may be capable of downloading lookup tables. The contamination controller 140 may select threshold values (for example, a threshold alkalinity value) from the lookup tables based on a number of factors including the pH, turbidity, free chlorine content, ORP value, or other parameters.

The present disclosure may improve swimming pool and spa user experience. The present disclosure may inform an operator or user of the swimming pool or spa about actions for mitigating contamination in the swimming pool or spa, may mitigate the contamination in the swimming pool or spa, and may inform a user of the status of the swimming pool or spa when a contamination mode is activated. The systems and methods described may provide the most up to date recommended actions for mitigating contamination by receiving the latest information regarding current disease vectors and other health information from a server.

Information and signals described herein may be represented using any of a variety of different technologies and techniques. For example, data, instructions, commands, information, signals, bits, symbols, and chips that may be referenced throughout the description may be represented by electromagnetic waves, voltages, currents, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by one or more processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B. For example, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), identifying, ascertaining, and the like. Also, “determining” can include receiving (for example, receiving information), accessing (for example, accessing data stored in memory), retrieving, and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

In other instances, other configurations of the systems and methods described herein are possible. For example, those of skill in the art will recognize, according to the principles and concepts disclosed herein, that various combinations, sub-combinations, and substitutions of the components discussed above can provide appropriate control for a variety of different configurations of robotic platforms for a variety of applications.

It will be appreciated by those skilled in the art that while the disclosure has been described above in connection with particular embodiments and examples, the disclosure is not necessarily so limited, and that numerous other embodiments, examples, uses, modifications and departures from the embodiments, examples, and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A method for mitigating contamination in a swimming pool or spa, the method comprising:
receiving a first input at a user interface to activate a contamination mode for the swimming pool or spa;
outputting an indication of one or more contamination mitigation options at the user interface in association with receiving the first input to activate the contamination mode;
receiving a second input at the user interface to select a contamination mitigation option from the one or more contamination mitigation options; and
performing one or more contamination mitigation actions associated with the selected contamination mitigation option.

2. The method of claim 1, wherein the first input at the user interface to activate the contamination mode is associated with a human contamination mode, the method further comprising:
activating the human contamination mode based at least in part on receiving the first input, wherein the one or more contamination mitigation options are provided in the form of one or more human contamination mitigation options associated with the human contamination mode.

3. The method of claim 1, wherein the first input at the user interface to activate the contamination mode is associated with an animal contamination mode, the method further comprising:
activating the animal contamination mode based at least in part on receiving the first input, wherein the one or more contamination mitigation options are provided in the form of one or more animal contamination mitigation options associated with the animal contamination mode.

4. The method of claim 1, wherein performing the one or more contamination mitigation actions associated with the selected contamination mitigation option further comprises:
outputting an alert that water of the swimming pool or spa may be contaminated, or that one or more pool chemical levels may be out of normal range.

5. The method of claim 1, wherein performing the one or more contamination mitigation actions associated with the selected contamination mitigation option further comprises determining whether water in the swimming pool or spa has been sanitized.

6. The method of claim 5, further comprising:
setting a flow rate of an ultraviolet (UV) sanitizer system to a first flow rate when the water in the swimming pool or spa has been sanitized; and
setting the flow rate of the UV sanitizer system to a second flow rate when the water in the swimming pool or spa has not been sanitized, wherein the second flow rate is slower than the first flow rate.

7. The method of claim 1, further comprising:
receiving an input at the user interface to activate a chlorination contamination mitigation option; and
outputting instructions for at least one chlorination dosage correlated with at least one time frame, wherein each of the at least one chlorination dosage and the correlated at least one time frame are associated with a respective time duration indicating when one or more pool chemical levels are expected to be within a normal range.

8. The method of claim 1, wherein performing the one or more contamination mitigation actions associated with the selected contamination mitigation option further comprises:
determining that an oxidation-reduction potential associated with the swimming pool or spa is outside a standard range; and
dosing water in the swimming pool or spa until the oxidation-reduction potential is within the standard range.

9. The method of claim 8, wherein the standard range for the oxidation-reduction potential is greater than 650 millivolts (mV).

10. The method of claim 1, further comprising:
determining a pH level of water in the swimming pool or spa, wherein the one or more contamination mitigation options are based at least in part on the determined pH level; and
selecting a dosage of an additional sanitizer to add to the water in the swimming pool or spa based at least in part on the determined pH level.

11. The method of claim 1, further comprising:
determining a level of at least one chemical in water of the swimming pool or spa, wherein the one or more contamination mitigation options are based at least in part on the level of the at least one chemical in the water of the swimming pool or spa; and
selecting a dosage of an additional sanitizer to add to water of the swimming pool or spa based on the level of at the least one chemical in the water of the swimming pool or spa.

12. The method of claim 1, further comprising:
receiving a third input associated with completion of the one or more contamination mitigation actions; and
deactivating the contamination mode based at least in part on receiving the third input.

13. A device for mitigating contamination in a swimming pool or spa, the device comprising:
a user interface designed to:
receive a first input to activate a contamination mitigation mode for the swimming pool or spa;
output an indication of at least one contamination mitigation option associated with the contamination mitigation mode; and
receive a second input to select a contamination mitigation option from the at least one contamination mitigation option; and
a controller designed to perform one or more contamination mitigation actions based at least in part on the selected contamination mitigation option.

14. The device of claim 13, wherein the user interface is further designed to:
output a first notification that the contamination mitigation mode has been activated.

15. The device of claim 14, wherein the controller is further designed to:
output a second notification to cease use of the swimming pool or spa to a mobile device of a user, wherein the second notification is associated with activation of the contamination mitigation mode.

16. The device of claim 13, wherein the controller is further designed to:
output a notification that water of the swimming pool or spa may be contaminated or that one or more pool chemical levels may be out of normal range, wherein the notification is associated with receiving the second input to select the contamination mitigation option from the one or more contamination mitigation options.

17. The device of claim 13, wherein the controller is further designed to:
output a query to a server to identify a current warning for water borne avian illnesses.

18. The device of claim 13, wherein the controller is further designed to:
output an alert to a server associated with a local animal control to test an animal found in the swimming pool or spa for at least one disease.

19. The device of claim 13, wherein the user interface is further designed to:
output a notification to backwash a filter and replace a media.

20. A swimming pool or spa control device, comprising:
a contamination controller associated with a pool pump, a pool filter, a chemical dispenser, and at least one other pool device, the controller designed to:
receive a first input at a user interface to activate a contamination mode associated with a contamination of the swimming pool or spa;
output an indication of one or more contamination mitigation options at the user interface;
receive a second input at the user interface to select at least one of the one or more contamination mitigation options;
perform one or more contamination mitigation actions associated with the at least one selected contamination mitigation option via at least one of the pool pump, pool filter, chemical dispenser, or the at least one other pool device; and
deactivate the contamination mode based at least in part on the performance of the one or more contamination mitigation actions.
